(19) United States
(12) Patent Application Publication
(10) Pub. No.: US 2011/0166876 A1
(43) Pub. Date: Jul. 7, 2011

(54) METHODS FOR DELIVERING A DRUG TO A PATIENT WHILE RESTRICTING ACCESS TO THE DRUG BY PATIENTS FOR WHOM THE DRUG MAY BE CONTRAINDICATED

(75) Inventors: Edward J. Chapman, Sparta, NJ (US); Christopher J. Linzer, Annandale, NJ (US)

(73) Assignee: CELGENE CORPORATION, Summit, NJ (US)

(21) Appl. No.: 12/989,503

(22) PCT Filed: Apr. 24, 2009
(86) PCT No.: PCT/US2009/041672

§ 371 Date: Mar. 1, 2011

Related U.S. Application Data
(60) Provisional application No. 61/047,944, filed on Apr. 25, 2008.

(51) Int. Cl. G06Q 50/00

(52) U.S. Cl. 705/2

(57) ABSTRACT

Methods for delivering a drug to a patient in need of the drug, while restricting access to the drug by patients for whom the drug may be contraindicated are disclosed. The methods are of the type in which prescriptions for the drug are filled by a pharmacy only after a computer readable storage medium has been consulted to retrieve a prescription approval code. Embodiments are provided wherein the patients are assigned to risk groups based upon the risk that taking the drug will lead to an adverse side effect, and certain additional information, such as periodic surveys and diagnostic tests probative of the ongoing risk of the side effect developing are obtained before prescriptions for the drug are approved.

### CROSS-REFERENCE TO RELATED APPLICATIONS

This application claims the benefit of U.S. Application No. 61/047,944 filed Apr. 25, 2008, the entire disclosure of which is incorporated herein by reference.

### FIELD OF THE INVENTION

The present invention relates to improved methods for delivering a drug to a patient. More particularly, the present invention relates to novel methods for delivering a teratogenic or other potentially hazardous drug to a patient in need of the drug, while avoiding the occurrence of known or suspected side effects of the drug. The novel methods permit the distribution to patients of drugs, particularly teratogenic or other potentially hazardous drugs, in ways wherein such distribution can be carefully monitored and controlled.

### BACKGROUND OF THE INVENTION

Many beneficial drugs are known or suspected of producing adverse side effects in certain individuals. These side effects may be manifest in the patient taking the drug, in a foetus (i.e. fetus) carried by the patient, or in a recipient (or foetus carried by a recipient) of the bodily fluids of the patient. In some cases, administration of the drug may be acceptable in some patients, but absolutely contraindicated in other patients. For example, drugs known or suspected of causing birth defects if taken by a pregnant woman (i.e. teratogenic drugs), may nonetheless be beneficial for treating certain conditions. However, because of the teratogenic or other potentially hazardous properties of the drug, administration to pregnant women must be avoided. As another example, certain drugs that are useful in treating patients with certain myelodysplastic syndromes (MDS) can also cause adverse events such as cytopenias, including neutropenia and thrombocytopenia. Other drugs are known which may be beneficially employed in the general population, but must be avoided by individuals having a certain preexisting condition, or those concurrently taking certain other medication(s), due to adverse side effects which may develop in those individuals.

One such drug which is known to produce adverse side effects, but which may nevertheless be beneficially employed in certain patients is thalidomide. Thalidomide is a drug which was first synthesized in Germany in 1957. Beginning in 1958, it was marketed in many countries for use as a sedative, although it was never approved for use in the United States. After reports of serious birth defects, thalidomide was withdrawn from all markets by 1962. However, during the years it was used, it was found to be effective in treating erythema nodosum leprosum (ENL), a condition of leprosy, and the U.S. Food and Drug Administration (FDA) has made the drug available for this specific use via a program of the Public Health Service. More recently, investigators have found that thalidomide may be effective in treating AIDS wasting and aphthous ulcers occurring in AIDS patients. In addition, treatments for other diseases, such as a number of neoplastic diseases including cancers, rheumatoid arthritis, and macular degeneration, are also believed to be possible. The FDA has recently approved an application by Celgene Corporation, which is the assignee of the present patent application, to market thalidomide for the treatment of ENL. The medical community anticipates that thalidomide will be used for treatment of additional conditions and diseases, including those set forth above. However, due to the severe teratogenic risk of thalidomide, methods are needed to control the distribution of this drug so as to preclude administration to foetuses.

Another such drug that is suspected of producing certain teratogenic side effects, and which is suspected to produce other adverse side effects, is lenalidomide. Lenalidomide (1-oxo-2-(2,6-dioxopiperidin-3-yl)-4-aminoisoindoline) is an analogue of thalidomide and is an immunomodulatory agent with anti-angiogenic and anti-neoplastic properties. Celgene Corporation has received FDA approval to market lenalidomide under the trade name REVLIMID® to treat patients with multiple myeloma (in combination with dexamethasone) who have received at least one prior therapy, and to treat patients with transfusion-dependent anemia due to Low- or Intermediate-1-risk myelodysplastic syndromes (MDS) associated with a deletion 5q cytogenetic abnormality with or without additional cytogenetic abnormalities. Because of its structural similarity to thalidomide, a known human teratogen, there is a risk that lenalidomide could cause serious birth defects in foetuses, and thus is contraindicated in pregnant women and women capable of becoming pregnant. As with thalidomide, methods are needed to control the distribution of this drug so as to preclude administration to foetuses.

Lenalidomide therapy is also associated with significant neutropenia and thrombocytopenia in some patients being treated for MDS, so patients taking lenalidomide need be monitored closely for cytopenias. In addition, lenalidomide can also significantly increase the risk of deep venous thrombosis (DVT) and pulmonary embolism (PE) in patients with multiple myeloma who were treated with lenalidomide combination therapy. Thus, methods for distribution of this and other potentially hazardous drugs are needed to guard against improper provision to persons for whom such drugs are contraindicated.

In this regard, U.S. Pat. Nos. 6,045,501, 6,561,976, 6,767,326, and 6,908,432 to Elsayed et al., provide methods for delivering a drug to a patient while preventing the exposure of a foetus or other contraindicated individual to the drug. According to the methods of these patents, prescriptions for the drug are filled only after a computer readable storage medium has been consulted to assure that the prescriber is registered in the medium and qualified to prescribe the drug, that the pharmacy is registered in the medium and qualified to fill the prescription for the drug, and the patient is registered in the medium and approved to receive the drug. Improvements to these methods may be useful, however, to minimize and simplify the demands on the pharmacy, thereby improving compliance with the system of distribution, and reducing the risk that the drug will be dispensed to a contraindicated individual.

Methods for monitoring and educating patients to whom a drug is distributed have been developed in connection with Accutane (isotretinoin). Accutane, which is a known teratogen, is a uniquely effective drug for the treatment of severe, recalcitrant, nodular acne. A pregnancy prevention program was developed, and the Slone Epidemiology Unit of Boston University designed and implemented a survey to evaluate these efforts. The survey identified relatively low rates of pregnancy during Accutane treatment, which suggests that such a program can be effective. With more than about 325,000 women enrolled to date in the Accutane survey, it is also clear that such a large-scale study can be conducted. Enrollment in the Accutane survey is voluntary, however. Accordingly, assessing the representativeness of the women who have been enrolled in the survey has been problematic, and it has been difficult to determine whether the survey results can be generalized to all female Accutane users. Thus, an improved survey is needed which would be representative of all users of a particular drug, such as thalidomide, who obtain the drug through legal distribution channels. There are also no mechanisms provided to assure compliance with the program or to limit distribution of the drug to participants in the survey.

Because drug sharing may frequently occur among AIDS patients, which may result in placing a foetus at risk, a program is needed which can be used to educate men and women about the risk of teratogenic or other potentially hazardous drugs, such as thalidomide and lenalidomide. In addition, a system is needed for the controlled distribution of a drug, in which of all users of the drug, including prescribers, pharmacies, and patients, may be accountable for their compliance with methods that may be established to minimize the risk that a contraindicated individual will be exposed to the drug. The present invention is directed to these, as well as other important ends.

### SUMMARY OF THE INVENTION

The present invention is directed to improved methods for delivering a drug to a patient in need of the drug, while avoiding the occurrence of an adverse side effect known or suspected of being caused by the drug, of the type in which prescriptions for the drug are filled only after a computer readable storage medium has been consulted to assure that the prescriber is registered in the medium and qualified to prescribe the drug, that the pharmacy is registered in the medium and qualified to fill the prescription for the drug, and the patient is registered in the medium. In one embodiment of the invention, there are provided improved methods comprising one or more of the steps of:

a. defining a plurality of patient risk groups based upon a predefined set of risk parameters for the drug;

b. defining a set of information to be obtained from the patient, which information is probative of the risk that such adverse side effect is likely to occur if the drug is taken by the patient;

c. in response to the information set, assigning the patient to at least one of the risk groups; and

d. entering the risk group assignment in the medium before the patient is approved to receive the drug.

In other embodiments of the present invention, there are provided improved methods comprising one or more of the steps of:

a. registering in a computer readable storage medium a spouse of the patient, a designated family member, or guardian to assist the patient in (1) taking the drug consistent with prescription guidelines; (2) preventing diversion of the drug; and/or (3) returning the drug if the drug is no longer suitable for the patient;

b. registering in the computer readable storage medium the spouse, designated family member, or guardian to return the drug to a pharmacy, a distributor of the drug, or manufacturer of the drug if the patient expires prior to using all of the drug;

c. obtaining the signed informed consent of a male sexual partner of the patient;

d. training the male sexual partner of the patient about methods of contraception; and

e. providing contraceptive education to the patient or the male sexual partner of the patient.

In one aspect of the invention, the drug is lenalidomide or thalidomide.

In another aspect of the invention, the patient is elderly, infirmed or impaired.

In another aspect of the invention, the male sexual partner returns the signed informed consent to a pharmacy, the distributor of the drug, or the manufacturer of the drug.

In another aspect of the invention, the contraception is a barrier or non-barrier method of contraception.

In another aspect of the invention, contraceptive counseling is provided by the physician, the pharmacist, or both.

In another embodiment of the invention, the patient, and/or one or more of the spouse of the patient, designated family member, or guardian is provided with a list of pharmacies qualified to dispense the drug.

In another embodiment, the present invention comprises a method for treating a patient known or suspected of suffering from myelodysplastic syndrome using a drug, while avoiding the occurrence of an adverse side effect known or suspected of being caused by the drug, wherein prescriptions for the drug are filled only after a computer readable storage medium has been consulted to assure that a prescriber is registered in the medium and qualified to prescribe the drug, a pharmacy is registered in the medium and qualified to fill the prescription for the drug, and the patient is registered in the medium, the method comprising the steps of:

a. defining a plurality of patient risk groups based upon a predefined set of risk parameters for the drug;

b. defining a set of information to be obtained from the patient, which information is probative of the risk that such adverse side effect is likely to occur if the drug is taken by the patient;

c. in response to the information set, assigning the patient to at least one of the risk groups;

d. entering the risk group assignment in the medium before the patient is approved to receive the drug;

e. registering in the computer readable storage medium a spouse of the patient, designated family member, or guardian to assist the patient in (1) taking the drug consistent with prescription guidelines; (2) preventing diversion of the drug; (3) returning the drug if the drug is no longer suitable for the patient; and/or (4) returning the drug to if the patient expires prior to using all of the drug.

In one aspect, the drug is lenalidomide or thalidomide.

In another aspect, the method further comprises:

f. obtaining the signed informed consent of a male sexual partner of the patient;

g. training the male sexual partner of the patient about methods of contraception; and

h. providing contraceptive education to the patient or the male sexual partner of the patient.

The method may also include a step of wherein the drug is returned to the pharmacy, a distributor of the drug, or a manufacturer of the drug.

In another embodiment, the invention includes a method for treating a patient known or suspected of suffering from multiple myeloma using a drug, while avoiding the occurrence of an adverse side effect known or suspected of being caused by the drug, wherein prescriptions for the drug are filled only after a computer readable storage medium has been consulted to assure that a prescriber is registered in the medium and qualified to prescribe the drug, a pharmacy is registered in the medium and qualified to fill the prescription for the drug, and the patient is registered in the medium, the method comprising the steps of:

a. defining a plurality of patient risk groups based upon a predefined set of risk parameters for the drug;

b. defining a set of information to be obtained from the patient, which information is probative of the risk that such adverse side effect is likely to occur if the drug is taken by the patient;

c. in response to the information set, assigning the patient to at least one of the risk groups;

d. entering the risk group assignment in the medium before the patient is approved to receive the drug; and

e. registering in the computer readable storage medium a designated family member or guardian to assist the patient in (1) taking the drug consistent with prescription guidelines; (2) preventing diversion of the drug; (3) returning the drug if the drug is no longer suitable for the patient; and/or (4) returning the drug to if the patient expires prior to using all of the drug.

In one aspect, the drug is lenalidomide or thalidomide.

In another aspect, the method further comprises:

f. obtaining the signed informed consent of a male sexual partner of the patient;

g. training the male sexual partner of the patient about methods of contraception; and

h. providing contraceptive education to the patient or the male sexual partner of the patient.

The method may also comprise the step of wherein the drug is returned to the pharmacy, a distributor of the drug, or a manufacturer of the drug.

In another embodiment, the invention comprises a method for treating a patient known or suspected of suffering from erythema nodosum leprosum using a drug, while avoiding the occurrence of an adverse side effect known or suspected of being caused by the drug, wherein prescriptions for the drug are filled only after a computer readable storage medium has been consulted to assure that a prescriber is registered in the medium and qualified to prescribe the drug, a pharmacy is registered in the medium and qualified to fill the prescription for the drug, and the patient is registered in the medium, the method comprising the steps of:

a. defining a plurality of patient risk groups based upon a predefined set of risk parameters for the drug;

b. defining a set of information to be obtained from the patient, which information is probative of the risk that such adverse side effect is likely to occur if the drug is taken by the patient;

c. in response to the information set, assigning the patient to at least one of the risk groups;

d. entering the risk group assignment in the medium before the patient is approved to receive the drug; and

e. registering in the computer readable storage medium a spouse of the patient, designated family member, or guardian to assist the patient in (1) taking the drug consistent with prescription guidelines; (2) preventing diversion of the drug; (3) returning the drug if the drug is no longer suitable for the patient; and/or (4) returning the drug to if the patient expires prior to using all of the drug.

In one aspect, the drug is thalidomide or lenalidomide.

In another aspect, the method further comprises:

f. obtaining the signed informed consent of a male sexual partner of the patient;

g. training the male sexual partner of the patient about methods of contraception; and

h. providing contraceptive education to the patient or the male sexual partner of the patient.

In some embodiment, the method further comprises wherein the drug is returned to the pharmacy, a distributor of the drug, or a manufacturer of the drug.

Other embodiments of the invention comprise methods for classifying information on patient identification into at least one patient risk group, which is executed on a computer comprising input/output means, processing means, and data storage means, the method comprising the steps of:

under control of the processing means, retrieving a prescription approval code from data storage means, wherein the prescription approval code is registered in the data storage means when the risk that an adverse side effect occurring in said patient is acceptable;

by the input/output means, inputting a set of information on said patient whose prescription approval code is retrieved in the above step, wherein the set of information comprises information that is probative of the risk that an adverse side effect is likely to occur if a drug is taken by said patient, and information on patient identification;

under the control of the processing means, comparing said information that is probative of risk with a predefined set of risk parameters for said drug, to assign said information on said patient identification into at least one patient risk group selected from a plurality of patient risk groups, which are classified based upon the predefined set of risk parameters for said drug and stored in the data storage means; and

outputting information showing classification of said patient into at least one patient risk group, information on registration of a prescriber and/or a pharmacy, and information on qualification to prescribe said drug and/or to fill the prescription for said drug by the input/output means.

In certain embodiments, the set of information includes the results of diagnostic testing, and wherein the method further comprises a step of, under the control of the processing means, comparing the results of diagnostic testing with the predefined set of risk parameters for said drug, to re-assign said information on said patient identification into at least one patient risk group selected from a plurality of patient risk groups.

In one embodiment, the method of the present invention further includes wherein the information that is probative of the risk relates to said side effect that is likely to arise in the patient.

In one embodiment, the method of the present invention further includes wherein the information that is probative of the risk relates to said side effect that is likely to arise in a foetus carried by the patient.

In one embodiment, the method of the present invention further includes wherein the information that is probative of the risk relates to said side effect that is likely to arise in a recipient or a foetus carried by a recipient of the bodily fluid of the patient.

In one embodiment, the method further comprises wherein a second set of information is collected from the plurality of patient risk groups on a periodic basis and stored in data storage means, and further comprises the steps of:

inputting a second set of information concerning said patient on a periodic basis by the input/output means; and

under the control of the processing means, comparing the input second set on information with the stored second set of information to re-assign said information on said patient identification into at least one patient risk group.

In other embodiments, the method of the present invention further comprises wherein said information on patient identification relates to a female of childbearing potential and said second set of information comprises the results of a pregnancy test.

In another embodiment, the method of the present invention further comprises, wherein said information that is probative of the risk relates to said adverse side effect comprising a teratogenic effect.

In another embodiment, the method of the present invention further comprises wherein said information that is probative of the risk relates to thalidomide or lenalidomide.

In another embodiment, the method of the present invention further comprises wherein said teratogenic effect is likely to arise in a foetus carried by said patient.

In another embodiment, the method of the present invention further comprises the steps of:

inputting information on a predefined set of risk parameters for said drug by the input/output means;

under the control of the processing means, retrieving information on patient identification stored in the data storage means so as to link a set of risk parameters based upon the predefined set of risk parameters to define the plurality of patient risk groups; and

under the control of the processing means, storing information on the plurality of patient risk groups in the data storage means.

In one embodiment, said set of information comprises the results of diagnostic testing. In certain embodiments of the invention, the diagnostic testing may comprise data with respect to levels of white blood cells in a patient. These data may be probative of the existence of neutropenia in a patient. In certain other embodiments of the invention, the additional information may comprise data with respect to levels of platelets in a patient. These data may be probative of thrombocytopenia in a patient. In other embodiments of the invention, the diagnostic testing may comprise data indicating whether a patient is pregnant. In certain embodiments of the invention, the diagnostic testing may comprise data probative of the risk of DVT or the risk of PE.

In one embodiment, said side effect is likely to arise in said patient.

In one embodiment, said side effect is likely to arise in a foetus carried by said patient.

In one embodiment, said side effect is likely to arise in a recipient or a foetus carried by a recipient of the bodily fluid of said patient.

In one embodiment, said method further comprises the steps of inputting a second set of information concerning said patient on a periodic basis by the input/output means; and under the control of the processing means, re-assigning said information on said patient identification into at least one patient risk group based on the input second set of information, wherein a second set of information is collected for the plurality of patient risk groups on a periodic basis and stored in the data storage means.

In one embodiment, said patient is a female of childbearing potential and said second set of information comprises the results of a pregnancy test.

In one embodiment, said adverse side effect comprises a teratogenic effect, deep venous thrombosis (DVT), pulmonary embolism (PE), neutropenia, and/or thrombocytopenia.

In one embodiment, said drug is thalidomide or lenalidomide.

In one embodiment, said teratogenic effect is likely to arise in a foetus carried by said patient.

In yet another embodiment, the invention comprises the steps of inputting information on a predefined set of risk parameters for said drug by the input/output means; under the control of the processing means, retrieving or receiving information on patient identification stored in the data storage means based upon the predefined set of risk parameters to define the plurality of patient risk groups; and under the control of the processing means, storing information on the plurality of patient risk groups in the data storage means.

A further embodiment of the present invention comprises a drug distribution management system located at a distributor where distribution of a drug having a potential risk of an adverse side effect is managed. The system of the invention comprises the steps of having a computer which (1) receives from a medical institution, a predefined set of parameters on a specific patient and information on assignment of the patient to a risk group. The predefined set of parameters and the information on assignment is stored in a storage medium of the computer. Next, (2) determining based on the parameters from the medical institution whether requirements for the patient to be assigned to the risk group are satisfied, and if the requirements are not satisfied, issuing an alert for the assigned patient risk group to be reviewed; (3) based on the parameters from the medical institution, determining with a predefined algorithm whether registration of the spouse of the patient, designated family member, or guardian is needed to assist the patient in taking the drug, and if the registration of the spouse, designated family member, or guardian is not included in the parameters despite such registration being required, issuing an alert to request the medical institution to enter a consent for such registration; (4) determining whether a prescription approval code is to be issued or denied based on a classification of said risk group and a decision on whether the registration of the spouse, designated family member, or guardian is required, and if said prescription approval code is determined to be issued, issuing the prescription approval code in association with the patient; and (5) receiving from a pharmacy qualified to fill a prescription for the drug, an application for filling a prescription for the drug along with the prescription approval code, whereby issuing a permission code for filling the prescription for the drug based on the prescription approval code that confirms the authenticity of the application and the information that the pharmacy is registered in the storage medium of the computer.

Additional embodiments of the present invention include a system through which any of the above described embodiments may be executed by a prescriber, pharmacist or patient via a online management system that may comprise a web server, a database server, and an email server provided in certain embodiments by the manufacturer or distributor of a drug.

The improved methods described herein provide advantageous and effective means for monitoring, controlling and authorizing the distribution to patients of drugs known or suspected of causing adverse side effects. The methods of the present invention include a variety of checks and balances which serve to limit unauthorized and possibly inappropriate distribution of the drug. These methods are particularly applicable to distribution of teratogenic or other potentially hazardous drugs, in which case the checks and balances may be particularly advantageous for preventing distribution of the drug to patients whose use of the drug may pose an unacceptable risk that a foetus carried by the patient or a recipient of the bodily fluids of the patient will be exposed to such drugs. Accordingly, the present methods may be advantageously used to avoid exposure of foetuses to teratogenic or other potentially hazardous drugs, thereby avoiding the terrible birth defects which may result from such exposure.

The invention is not limited to the distribution of teratogenic drugs; other potentially hazardous drugs may also be distributed in accordance with embodiments of this invention and such drugs may be distributed in such a fashion that persons for whom such drugs are contraindicated will not receive them. These and other aspects of the invention will become more apparent from the present description and claims.

### BRIEF DESCRIPTION OF THE DRAWINGS

FIG. 1 is a diagram that illustrates an embodiment of the present invention where a medical institution, a pharmacy and a drug distribution institution are interconnected through network.

FIG. 2 is a diagram that illustrates an embodiment of the present invention where information is communicated between a medical institution, a pharmacy, and a drug distribution institution according to a system of the present invention.

FIG. 3 is a diagram that illustrates the structure of a system according to an embodiment of the present invention.

### DETAILED DESCRIPTION OF ILLUSTRATIVE EMBODIMENTS

The present invention is directed generally to methods for the delivery of drugs known or suspected of causing an adverse side effect, especially teratogenic drugs, to patients. The term “drug,” as used herein, refers to any substance which is intended for use in the diagnosis, cure, mitigation, treatment or prevention of disease, or to affect the structure or function of the body. The term “side effect” refers to any abnormality, defect, mutation, lesion, degeneration or injury which may be caused by taking the drug. The side effect may be one which is likely to arise in the patient or in a foetus (i.e., fetus) carried by the patient. The side effect may also be one which is likely to arise in a recipient of the bodily fluid of the patient, or foetus carried by such recipient. The term “likely to arise” means that the side effect known or suspected of being caused by the drug may be expected to occur at a higher incidence rate in a particular individual or group of individuals.

Generally speaking, the methods of the present invention may be desirably and advantageously used to educate and reinforce the actions and behaviors of patients who are taking a drug, as well as prescribers who prescribe the drug and pharmacies which dispense the drug. As used herein, the term “prescriber” refers to any individual who is capable of prescribing drugs, including, for example, a medical doctor. The term “prescriber” as used herein also encompasses clinical researchers, clinical staff, and investigators. Such education and reinforcement of actions and behavior are often necessary to ensure proper prescribing and dispensing of the drug, as well as patient compliance with taking the drug. A wide variety of educational materials may be employed to ensure proper prescribing, dispensing and patient compliance according to the methods described herein, including, for example, a variety of literature and other materials, such as, for example, product information, educational brochures, continuing education monographs, videotapes and the like which may describe the risks and benefits associated with taking the particular drug and measures which may be taken to avoid those risks.

The methods described herein may be advantageously employed to avoid delivery of one or more drugs known or suspected of causing an adverse side effect to a patient for whom the drugs may be contraindicated. As used herein, the term “contraindicated” refers to any condition in a patient which renders a particular line of treatment, including the administration of one or more drugs, undesirable or improper. This condition may be preexisting, or may develop while the patient is taking the drugs, including conditions which may result directly or indirectly from treatment with the drugs. Thus, contraindicated drugs include, for example, teratogenic drugs whose administration, for example, to pregnant patients is importantly avoided due to the risks to the foetus. Drugs may also be considered “contraindicated,” as the term is used herein, if use of a drug by patients who are also taking another drug is known or suspected of producing an adverse side effect in those patients, or in a foetus carried by such patients. Contraindicated drugs also include, for example, drugs whose administration results in the occurrence of, for example, blood disorders or blood clots.

The methods of the present invention are especially advantageously employed for the delivery to a patient of a teratogenic drug. The delivery of a teratogenic drug to a patient may be advantageously achieved with the present methods while substantially (including completely) avoiding the delivery of the drug to a foetus. The term “substantially,” as used in reference to avoiding the delivery of a teratogenic drug to a foetus, generally means that there is an avoidance rate of delivering the drug to a foetus of greater than about 50%. Preferably, the avoidance rate is greater than about 55%, with an avoidance rate of greater than about 60% being more preferred. Even more preferably, the avoidance rate is greater than about 65%, with an avoidance rate of greater than about 70% being still more preferred. Yet more preferably, the avoidance rate is greater than about 75%, with an avoidance rate of greater than about 80% being still more preferred. In even more preferred embodiments, the avoidance rate is greater than about 85%, with an avoidance rate of greater than about 90% being yet more preferred. Still more preferably, the avoidance rate is greater than about 95%. In particularly preferred embodiments, a teratogenic drug may be delivered to patients with completely no delivery to foetuses (i.e., 100% avoidance rate).

The methods of the present invention can also be employed to monitor the health of a patient taking a potentially hazard drug for the occurrence of an adverse side effect and thereby determine whether the risk to the patient outweighs the benefits of therapy.

The drug delivery methods of the present invention preferably involve, inter alia, registering in a computer readable storage medium prescribers who are qualified to prescribe the involved drug, including, for example, teratogenic drugs. Once registered in the computer readable storage medium, the prescriber may be eligible to prescribe the drug to patients in need of the drug. Generally speaking, in order to become registered in the computer readable storage medium, the prescriber may be required to comply with various aspects of the methods described herein including, for example, providing patient education and counseling, and the like, as described in detail below. The registration of the prescriber in the computer readable storage medium may be achieved by providing the prescriber, for example, by mail, facsimile transmission, or on-line transmission with a registration card or on/off-line form, preferably together with appropriate educational materials concerning, for example, the particular drug for which the prescriber is being registered to prescribe, as well as suitable methods for delivering the drug to the patient, including the drug delivery methods described herein. The prescriber will preferably complete the registration card or form by providing information requested therein, and the registration card or form will preferably be returned to the manufacturer or distributor of the drug, or other authorized recipient of the registration materials, for example, by mail, facsimile transmission or on-line transmission. Information which may be requested of the prescriber in the registration card or form may include, for example, the prescriber's name, address, and affiliation, if any, with one or more health care institutions. The prescriber's information in the registration card or form is then entered into the computer readable storage medium. It is contemplated that the registration of the prescriber into the computer readable storage medium may also be achieved, for example, by telephone, and/or through the use of an integrated voice response system. Suitable computer readable storage media which may be employed for registration of the prescribers (as well as the pharmacies and patients, as discussed below) will be apparent to one of ordinary skill in the art, once armed with the teachings of the present application.

In a preferred embodiment, the above mentioned information on the prescriber is transmitted to a system located at a manufacturer or distributor of the drug (i.e., “a distributor side”), and is registered in the computer readable medium of the system. The system may provide a web based user interface on-line or off-line for inputting the prescriber's information mentioned above and may electrically receive the information to register it into the computer readable medium.

In accordance with the methods described herein, pharmacies who are qualified to fill prescriptions for the particular drug being prescribed including, for example, teratogenic drugs, are also preferably registered in a computer readable storage medium. The computer readable storage medium in which the pharmacies are registered may be the same as, or different from the computer readable storage medium in which the prescribers are registered. Once registered in the computer readable storage medium, the pharmacies may be eligible to dispense the involved drug to patients who are in need of the drug. Generally speaking, in order to become registered in the computer readable storage medium, the pharmacy may be required to comply with various aspects of the methods described herein including, for example, registering the patient (preferably also in a computer readable storage medium), ensuring that the patient complies with certain aspects of the drug delivery methods, as well as other aspects of the present methods, as described in detail below. As with the registration of the prescriber in the computer readable storage medium, the registration of the pharmacy may be achieved by providing the pharmacy, for example, by mail, facsimile transmission, or on-line transmission, with a registration card or form, preferably together with appropriate educational materials concerning, for example, the particular drug for which the pharmacy is being registered to dispense, as well as suitable methods for delivering the drug to the patient, including the drug delivery methods described herein. The pharmacy may then have the registration card or form completed by providing the information requested therein, which thereafter may be returned to the manufacturer or distributor of the drug, or other authorized recipient of the registration card or form, for example, by mail, facsimile transmission or on-line transmission. Information which may be requested of the pharmacy in the registration card or form may include, for example, the pharmacy's name, address, and affiliation, if any, with any health care institution such as, for example, a hospital, health care organization, and the like. The pharmacy's information in the registration card or form is then preferably entered into the computer readable storage medium. It is contemplated that the registration of the pharmacy into the computer readable storage medium may also be achieved, for example, by telephone and/or through the use of an integrated voice response system.

In a preferred embodiment, the above mentioned information on the pharmacy is transmitted to the system located at a manufacturer or distributor (i.e., “a distributor side”) of the drug, and is registered in the computer readable medium of the system. The system may provide a web based user interface on-line or off-line for inputting the pharmacy's information mentioned above and may electrically receive the information to register it into the computer readable medium.

As noted above, the drug delivery methods described herein also preferably involve the registration of the patient in a computer readable storage medium. The computer readable storage medium in which the patients are registered may be the same as, or different from the computer readable storage medium in which the prescriber and/or pharmacy is registered. Generally speaking, in order to become registered in the computer readable storage medium, the patient may be required to comply with various aspects of the methods described herein. The registration of the patient may be carried out by the registered pharmacy, for example at the time of the patient's initial visit to the pharmacy. It has been found, however, that it may be more efficient, and better compliance with the methods of the present invention may be provided, if registration of the patient is carried out by the registered prescriber of the drug at the time the initial prescription is generated.

In preferred form, the prescriber will typically have a registration card or form filled out for the patient, which includes information on the patient, such as the patient's name, sex, mailing address, date of birth, and the like. Information on the prescribing prescriber and dispensing pharmacy, such as the information described above for the registration thereof, may also be desirably entered on the patient registration card or form. The completed card or form may then be forwarded to the manufacturer or distributor of the drug, or other authorized recipient of the registration form, for example, by mail, facsimile transmission or on-line transmission. Where registration is by mail or facsimile, entry of the registration into the computer readable storage medium may preferably include the use of optical character recognition (OCR) software. It is also possible that the registration of the patient into the computer readable storage medium may also be achieved, for example, by telephone and/or through the use of an integrated voice response system.

In a preferred embodiment, the above mentioned information on the patient is transmitted to the system located at a manufacturer or distributor (i.e., “a distributor side”) of the drug, and is registered in the computer readable medium of the system. The system may provide a web based user interface on-line or off-line for inputting the patient's information mentioned above, and may electrically receive the information to register it into the computer readable medium.

Preferably, information will also be collected from the patient that may be probative of the risk that a known or suspected side effect will occur if the drug is taken by the patient. This information may then be compared with a predefined set of risk parameters for the drug, which in turn define a plurality of risk groups, so that analysis of the information will permit assignment of the patient to at least one of the risk groups. Preferably, this risk group assignment is then also entered into the computer readable storage medium. This assignment may be performed by the prescriber, who may then include the risk group assignment on the patient's registration card or form, or may be performed by another individual, such as a nurse, technician, or office personnel, who preferably interprets the information and assigns the patient to one of the risk groups, accordingly.

In a preferred embodiment, the assignment of the risk group is also transmitted to the system located at a manufacturer or distributor (i.e., “a distributor side”) of the drug, and is registered in the computer readable medium of the system. The system may provide a web based user interface on-line or off-line for prescriber for inputting the assignment of the risk group as well as the patient's information mentioned above, and may electrically receive the assignment of the risk group to register it into the computer readable medium.

As discussed above, it is preferable that a plurality of risk groups, each based upon a predefined set of risk parameters, be established for the drug which is to be administered. As will be evident to those of skill in the art, the risk parameters to be considered and the risk groups defined by those parameters, will be based upon factors which influence the risk that a known or suspected adverse side effect will occur if the patient receives the drug, and will vary depending upon the drug in question. Where the drug is a teratogenic drug, for example, such risk parameters may include elements which would impact the risk of a foetus being exposed to the drug, such as the age, sex and reproductive status of the patient. For example, a first risk group may comprise female patients of child bearing potential; a second risk group may comprise female patients of non-child bearing potential; a third risk group may comprise sexually active male patients; a risk group may comprise sexually inactive male patients. Additionally, there may be a risk group established for patients to whom administration of the drug may be strictly contraindicated, and patients assigned to such a group will not be approved to receive the drug. For other drugs, different factors, such as those influencing the likelihood that certain preexisting conditions may exist, or the likelihood of certain other drugs being used concomitantly with the prescribed drug, may define the relevant risk parameters.

In a preferred embodiment, the definition of a plurality of the risk groups and risk parameters that are established for the drug to be administered are also stored in the computer readable medium at the system located at the drug distributor side. In this embodiment, the system is constructed to facilitate assurance, based on the assignment of the risk group, risk parameters, patient information and prescriber information, that assignment of the risk group was conducted correctly by following the predetermined steps of assigning a patient to the risk group for the drug to be administrated.

By assigning each patient to a risk group, the steps that will be taken to minimize the chance that the drug is dispensed to a contraindicated patient, and to minimize the risk that a known or suspected adverse side effect will occur, can be tailored to suit the circumstances of that particular patient. For example, depending upon which risk group a patient is assigned to, additional information may be collected from the patient. As discussed more fully below, such additional information may be in the form, for example, of a patient survey. Such additional information may also include the results of certain diagnostic tests which have been performed. Based upon the additional information, the patient's risk group assignment may then remain the same, or the patient may be assigned to a different risk group, which may in turn require that further additional information be collected from the patient.

In a preferred embodiment, the system located at the distributor side will determine based on the above mentioned steps whether or not the additional information may be required. The system will issue an alert when it determines that additional information is required. In this case, the system may transfer the alert to the prescriber to collect the additional data from the patient and input the data to the system.

In accordance with the present invention, the monitoring of two, three or more drugs either administered to or proposed for administration to a patient may also be accomplished in order to avoid or diminish the likelihood of the occurrence of one or more side effects. Thus, combinations of drugs which, when administered to an individual patient, may give rise to an increased likelihood of side effects, may be registered in a computer readable storage medium, and the patient's risk group assignment may be reflective of this increased risk. A physician is registered to prescribe at least one of the drugs for a patient and a pharmacy is registered to fill such prescription. In this way, through assignment of such patient to one or more risk groups, the avoidance of harmful drug interactions may be attained.

It is preferred that for any given risk group, there may be defined a predetermined additional set of information which is to be collected from the patient. This additional set of information may be obtained prior to the initial dispensation of the drug to the patient and/or may be obtained from the patient on a periodic basis. This information may include information not previously obtained from the patient, or may simply reiterate previously asked questions, and repeat diagnostic tests which were conducted previously. The information may relate to the patient's conduct, or may relate to the patient's past or ongoing medical treatment, such as other procedures or medication which the patient may have received or is still receiving. For example, the additional set of information may be in the form of a survey or questionnaire regarding the patient's behavior and compliance with risk avoidance measures and may thus be probative of whether the risk of occurrence of an adverse side effect has increased, decreased or remained the same. Based upon the responses by the patient, the patient's risk group assignment may, if appropriate, be changed accordingly. Alternatively, where side effects which are known or suspected of being caused by a combination of drugs, the questions asked of the patient may be probative of the likelihood that the patient may take such a combination of drugs. Similarly, where sharing of drugs by the patient may be a matter of concern, the survey may be probative of the risk that the patient may be sharing the hazardous drug with another, and hence increase the risk that a contraindicated individual may receive the drug.

The additional information may also include the results of certain diagnostic tests which have been performed on the patient. Such diagnostic tests may be probative, for example, of the risk of exposure of a foetus to a teratogenic drug, may test for the presence of a risk factor for the adverse side effect of concern, or may be probative of the onset of that side effect. Where the use of combinations of more than one drug are known or suspected of causing an increased risk of the occurrence of a side effect, the diagnostic testing may include testing for the presence of one or more of those drugs, or evidence of the use by the patient of such other drugs. Additionally, diagnostic tests may be probative of the concentration of one or more drugs, including the prescribed drug or drugs, to assure that appropriate dosing is maintained. In certain embodiments of the invention, the additional information may comprise data with respect to levels of white blood cells in a patient. These data may be probative of the existence of neutropenia in a patient. In certain other embodiments of the invention, the additional information may comprise data with respect to levels of platelets in a patient. These data may be probative of thrombocytopenia in a patient. In certain embodiments of the invention, the diagnostic testing may comprise data probative of the risk of DVT or the risk of PE.

Such diagnostic testing may be conducted on any bodily fluid or waste product of the patient, including the blood, serum, plasma, saliva, semen or urine, as well as the feces. Diagnostic testing may also be performed on a biopsy of any tissue of the patient or may include genetic testing, which may be indicative of a genetic predisposition to a particular adverse side effect. Other forms of diagnostic testing, such as diagnostic imaging, or tests which may be probative of the proper functioning of any tissue, organ or system are also contemplated. Preferably, the additional information and/or diagnostic test results are obtained and entered in the computer readable storage medium before the patient is approved to receive the drug. Additionally, where the information indicates that the risk of the adverse side effect occurring outweighs the potential benefit of the drug, the patient may be assigned to a risk group that will preclude approval of dispensation of the drug to that patient.

In accordance with the methods of the present invention, therefore, the delivery of the drug to the patient may involve the following steps. As a prelude to prescribing and dispensing the drug to the patient, the prescriber and the pharmacy are registered in one or more appropriate computer readable storage media, as described above. If the prescriber is not registered in the computer readable storage medium, the prescriber will be ineligible to prescribe the drug. Similarly, if the pharmacy is not registered in the computer readable storage medium, the pharmacy will be ineligible to dispense the drug.

In the course of an examination of a patient, including patients suffering from one or more diseases and/or disorders such as, for example, erythema nodosum leprosum (ENL) or multiple myeloma, the prescriber may determine that the patient's condition would be improved by the administration of a drug such as, for example, a teratogenic drug or a suspected teratogenic drug, including thalidomide and lenalidomide. Prior to prescribing the drug, the prescriber preferably counsels the patient, for example, on the various risks and benefits associated with the drug. For example, the prescriber preferably discusses the benefits associated with taking the drug, while also advising the patient on the various side effects associated therewith. In embodiments of the invention wherein the prescriber assigns the patient to a specific risk group, the disclosure is preferably tailored to that risk group assignment. Thus, a patient who may acquire or impart a condition or disease for which the drug is contraindicated is preferably counseled by the prescriber on the dangers associated therewith and advised as to risk avoidance measures which may be instituted. Preferably the patient is provided full disclosure of all the known and suspected risks associated with taking the drug. For example, in the case of teratogenic drugs or drugs suspected of being teratogenic, the prescriber preferably counsels the patient on the dangers of exposing a foetus, either one which may be carried by the patient or one carried by a recipient of the bodily fluids of the patient, to the teratogenic drug or drugs suspected of being teratogenic. Such counsel may be provided verbally, as well as in written form. In preferred embodiments, the prescriber provides the patient with literature materials on the drug for which a prescription is contemplated, such as product information, educational brochures, continuing education monographs, and the like. Thus, in the case of methods involving teratogenic drugs or drugs suspected of being teratogenic, the prescriber preferably provides patients with literature information, for example, in the form of the aforesaid product information, educational brochures, continuing education monographs, and the like, warning the patient of the effects of the drug (known or suspected) on foetuses. In the case of other drugs which are known or suspected of causing an adverse side effect, the patient is counseled as to the dangers of taking the drugs, and of steps which may be taken to avoid those risks. For example, if the concomitant use of the drug and another drug, for example alcohol, is to be avoided, the prescriber advises the patient of the risks of drinking alcohol while taking the drug.

With particular reference to counseling provided in connection with teratogenic drugs and drugs suspected of being teratogenic, the prescriber preferably counsels female patients that such drugs must never be used by pregnant women. If the patient is a female of child-bearing potential (i.e., a woman who is capable of becoming pregnant), the prescriber preferably counsels the patient that even a single dosage of certain teratogenic drugs or drugs suspected of being teratogenic, such as thalidomide and lenalidomide, may cause birth defects. Accordingly, the patient is preferably counseled to avoid sexual intercourse entirely, or if sexually active, to use appropriate forms of contraception or birth control. For both male and female patients, the prescriber preferably provides counsel on the importance of using at least two forms of effective birth control methods, with one form preferably being a highly effective hormonal method, and the other form preferably being an effective barrier method. The patients are preferably counseled to use the birth control methods for a period of time prior to and during treatment with the teratogenic drug or drug suspected of being teratogenic, as well as for a period of time after treatment with the drug has been terminated. In preferred embodiments, the patient is counseled to use at least two forms of birth control for at least about 4 weeks prior to initiation of treatment, during treatment, and for at least about 4 weeks after treatment has been terminated. It may be desirable for the prescriber to personally provide female patients who are capable of becoming pregnant with one or more contraceptive devices or formulations.

Male patients who are being prescribed a teratogenic drug or drug suspected of being teratogenic are preferably counseled to use condoms every time they engage in sexual relations, since many teratogenic drugs or drugs suspected of being teratogenic may be found in semen. Male patients are also preferably counseled to contact their prescriber if they have sexual intercourse without a condom, and/or if it is believed that they may have caused a pregnancy. As with female patients, it may be desirable for the prescriber to provide male patients who are capable of impregnating female patients with a contraceptive device or formulation. Other advice relative to birth control that the prescriber may provide to the patient would be apparent to one skilled in the art, once armed with the teachings of the present application. If the prescriber who is prescribing the teratogenic drug or drug suspected of being teratogenic is unaware of certain aspects of the available forms of birth control and the advantages and disadvantages associated therewith, the patient should be referred to a prescriber who is knowledgeable on such matters, prior to be being prescribed the involved drug. Generally speaking, as discussed below, counseling on teratogenecity, birth control, and the like is preferably given only to female patients who are capable of becoming pregnant, or to male patients who are capable of having sexual relations with partners who are or can become pregnant. In this manner, unnecessary counseling, for example, to women who are no longer of child-bearing age or men who are incapable of sexual relations with such women, may be avoided.

With further reference to methods involving teratogenic, suspected teratogenic, or other potentially hazardous drugs, it is also preferred that the prescriber advise the patient to not share the drug with anyone else, and particularly that the drug should be kept out of the reach of children as well as women of child-bearing potential. In the case of female patients, particularly female patients of child-bearing potential, the prescriber should give the patient a pregnancy test, preferably a serum pregnancy test, prior to and during treatment with the teratogenic drugs and drugs suspected of being teratogenic. To begin receiving the teratogenic drug or drug suspected of being teratogenic and to continue taking the drug, female patients of child-bearing potential should continue to have negative pregnancy tests. In certain embodiments of the invention, a patient may be tested for pregnancy (a) before drug administration; (b) once per week during the first 28 days of drug administration; and/or (c) following the conclusion of a course of treatment comprising drug administration. In other embodiments of the invention, a patient may be tested for pregnancy 10, 11, 12, or 14 days before a prescription is written and again within 24 hours before a prescription is written.

With further reference to certain embodiments of the invention involving drugs capable of causing neutropenia or thrombocytopenia, such as lenalidomide, a prescriber may monitor blood counts of a patient. For example, blood counts can be monitored every 2 weeks for the first 12 weeks of administration of a drug and then at least monthly thereafter. By way of additional example, blood counts can be monitored every 2 weeks for the first 8 weeks of administration of a drug and then at least monthly thereafter. In certain embodiments of the invention, to begin receiving a drug capable of causing neutropenia or thrombocytopenia and/or to continue taking the drug, patients should have acceptable blood counts. In certain other embodiments of the invention, to begin receiving a drug capable of causing neutropenia or thrombocytopenia and/or to continue taking the drug, patients should receive blood transfusions or one or more medications capable of ameliorating unfavorable or low blood counts.

The patient is also preferably counseled by the prescriber to discard or return to the prescriber, pharmacy, manufacturer or distributor any unused portion of the prescribed drug.

As would be apparent to one of ordinary skill in the art, once armed with the teachings of the present application, one or more aspects of the counseling described above may be applicable, in certain circumstances, for drugs other than teratogenic drugs.

In addition to receiving counseling on the drug being prescribed, including counseling, for example, on birth control, and prior to receiving a prescription for the drug, the methods of the present invention preferably involve requiring the patient to fill out an informed consent form which is signed by the prescriber, as well as the patient. The prescriber should retain a copy of the informed consent form for his/her records. Verification that the patient has given his/her informed consent may also be registered in the computer readable storage medium. Preferably, this verification is provided by the prescriber, and may be included, for example, with the patient registration information and risk group assignment. It has surprisingly been found that by having the prescriber, rather than the pharmacy, verify the patient's informed consent, the methods of the present invention may operate more efficiently, leading to better compliance, and hence decreased risk that the adverse side effect will occur, may be achieved.

By filling out and signing an informed consent form, the patient acknowledges that he/she understands the risks associated with taking the drug. In the informed consent form, the patient preferably agrees to comply with the risk avoidance measures provided, and to behave in a manner which is consistent with the prescriber's counsel. For example, in cases involving, for example, teratogenic drugs or drugs suspected of being teratogenic, the patient may agree to use at least one form of birth control, with female patients agreeing to use at least two forms of birth control. In preferred embodiments, where the patient's risk group assignment so dictates, the patient will agree to undergo periodic diagnostic testing relevant to the risk that the adverse side effect to be avoided may occur or be occurring. In preferred embodiments involving teratogenic drugs or drugs suspected of being teratogenic, female patients preferably agree also to undergo pregnancy testing, preferably serum pregnancy testing, before, during and after treatment with the teratogenic drug or drug suspected of being teratogenic. In certain embodiments of the invention, a patient may be tested for pregnancy (a) before drug administration; (b) once per week during the first 28 days of drug administration; and/or (c) following the conclusion of a course of treatment comprising drug administration. In other embodiments of the invention, a patient may be tested for pregnancy 10, 11, 12, or 14 days before a prescription is written and again within 24 hours before a prescription is written. Female patients preferably will also acknowledge that, at the time they are being prescribed the drug, especially teratogenic drugs and drugs suspected of being teratogenic, they are not pregnant, they will immediately stop taking the drug if they become pregnant, and they will not try to become pregnant for at least 4 weeks after treatment with the drug is terminated. Female patients, especially female patients for whom a teratogenic drug or drug suspected of being teratogenic will be administered, preferably further agree to contact their prescriber if they wish to change one or more of the birth control methods being used and to have an additional pregnancy test if a menstrual period is missed. Female patients, especially female patients to be treated with teratogenic drugs and drugs suspected of being teratogenic, will preferably agree also to not breast-feed while being treated with the drug.

Male patients who are being prescribed the drugs according to the methods described herein, especially teratogenic drugs and drugs suspected of being teratogenic, will preferably agree to avoid having unprotected sexual relations with a woman, particularly a woman of child-bearing potential during treatment with the drug. In doing so, male patients will preferably further agree to use a condom during sexual relations with a woman, with latex condoms being preferred. Both male and female patients will also preferably agree to not share the drug with anyone, and to acknowledge that they cannot donate blood while taking the drug, with male patients agreeing also to not donate sperm while taking the drug. In addition, the patients will preferably agree to take part in a confidential patient survey, for example, before, during and after treatment with the drug. The patient survey provides information, for example, to the prescriber, manufacturer and/or distributor of the drug, as well as any group or body which may be established to generally provide oversight on the distribution of the drug, on information regarding the general lifestyle of the patient, including detailed information on the patient's sexual behavior. In this manner, the survey may assist in identifying patients who engage in risky behavior, as well as patients who are non-compliant with the methods described herein. Such risky behavior and/or non-compliance may lead to a suspension or intervention of the patient's treatment with the drug, with re-education being provided to the patient.

The information obtained from the survey is preferably also entered into the computer readable storage medium. Once entered into the computer readable storage medium, the prescriber, manufacturer and/or distributor of the drug may be able to glean therefrom information regarding the level of risk associated with the administration of the involved drug to the various patients. Accordingly, it may be possible to identify, from among the entire population of registered patients, one or more subpopulations of patients for which the involved drug may be more likely to be contraindicated. For example, it may be possible to identify a subpopulation of female patients who are capable of becoming pregnant and/or a subpopulation of male patients who are capable of impregnating female patients. Preferably, the counseling information discussed above relating to exposure of a foetus to a teratogenic drug or drug suspected of being teratogenic may then be addressed primarily to this subpopulation of patients.

If the risk is considered to be acceptable, the patient may continue to receive the drug, using the methods described herein. If the risk is considered to be unacceptable, additional counseling may be provided to the patient or, if necessary, treatment of the patient with the involved drug may be terminated, with alternate treatment modalities being provided. In preferred embodiments, female patients will agree to complete a patient survey at least once every month, with male patients agreeing to complete a patient survey at least once every three to six months. The survey may be conducted by mail, facsimile transmission, on-line transmission or by telephone. Preferably, the survey is conducted by telephone through the use of an integrated voice response system (IVR).

After the patient has received counseling as described above, and has also filled out and signed an informed consent form, and it is determined that the drug which is to be prescribed is not contraindicated for the patient (such as, for example, a negative pregnancy test in the case of female patients for whom a prescription is desired for a teratogenic drug or drug suspected of being teratogenic), the prescriber may prescribe the drug to the patient. In preferred embodiments of the present invention, the amount of the drug which is prescribed to the patient is for a limited amount, preferably no more than about 28 days. Refills for the drug will not be permitted without a renewal prescription from the prescriber, as discussed in detail below. In order to have the prescription filled, the patient preferably presents the prescription and the informed consent form to a pharmacy who has been registered, as discussed above. It is contemplated that the patient may bring the prescription to an unregistered pharmacy. If so, the pharmacy may take steps to become registered, for example, by immediately contacting the manufacturer of the drug. Once registration of the pharmacy is completed, the distribution procedure described herein may resume, per the discussion hereinafter. Of course, this may introduce a delay into the prescription process, and the patient may desire to take the prescription for the drug to an alternate, registered pharmacy. If the patient does not present a completed informed consent form to the pharmacy, or if verification of such informed consent has not previously been registered in the computer readable storage medium, the prescription may not be filled. In this case, pharmacy may contact the prescribing prescriber to have an informed consent form filled out for the patient.

The drug is preferably supplied to the pharmacy (as well as the patient) in packaging, such as individual blister packs, which includes warnings regarding the risks associated with the drug, as well as the importance of various aspects of the present methods such as, for example, pregnancy testing and the use of contraception (in the case of teratogenic drugs and drugs suspected of being teratogenic), and the dangers associated with sharing the drug with others, among other aspects.

As noted above, the drug is preferably prescribed and dispensed to the patient in a limited amount, with a prescription amount of no more than about 28 days being preferred, and preferably with no refills being permitted. Thus, for the patient to obtain an additional prescription, it is generally necessary for the patient to have a follow-up visit with the prescriber. Such a follow-up visit preferably takes place at least each time the patient requires a renewal of the prescription, and possibly more often if the patient requires, for example, additional counseling. At the follow-up visit, the patient will preferably receive additional counseling regarding the risks and benefits associated with taking the drug, as well as further counseling on birth control (if applicable). The patient will also preferably complete an additional patient survey to provide current information regarding their lifestyle, including their sexual behavior and, if female of childbearing potential, be administered a new pregnancy test. In certain embodiments of the invention, a patient may be tested for pregnancy (a) before drug administration; (b) once per week during the first 28 days of drug administration; and/or (c) following the conclusion of a course of treatment comprising drug administration. In other embodiments of the invention, a patient may be tested for pregnancy 10, 11, 12, or 14 days before a prescription is written and again within 24 hours before a prescription is written.

After receiving the counseling and completing the patient survey, and if the pregnancy tests for female patients are negative, the prescriber may fill out a new prescription for the drug. As with the original prescription, the renewal prescription is preferably for a limited period of time, with no more than about 28 days being more preferred.

In certain embodiments, the prescriber may also receive reminders, for example, via mail, facsimile, or on-line transmission, from the manufacturer, distributor or other group or body providing oversight on drug distribution, that the prescriber has prescribed a hazardous drug to patients which may be contraindicated, and that the involved patients may require additional counseling and diagnostic testing. Such reminders may preferably be delivered to the prescriber, for example, from about 14 to about 21 days after the previous prescription was filled.

As with the original prescription from the prescriber, the patient should present all renewal prescriptions to a registered pharmacy. Prior to filling out the prescription and dispensing the drug, the pharmacy preferably confirms, for example, via a standard on-line transmission or via telephone via IVR that the patient has been registered and is eligible to receive the drug. When patient eligibility has been confirmed, the pharmacy may dispense the drug to the patient. If the patient is ineligible, the pharmacy generally may not dispense the drug to the patient. The pharmacy may then contact, for example, the prescribing prescriber or the manufacturer of the drug to initiate patient registration. In preferred form, the pharmacy will be precluded from dispensing the drug if the patient has more than about 7 days of drug supply from the previous prescription, and/or if the new prescription was written more than about 14 days before the date the patient visits the pharmacy to have it filled.

The registration into one or more computer readable storage media of the prescriber, pharmacy and patient, according to the methods described herein, provide a means to monitor and authorize distribution of contraindicated drugs, including teratogenic drugs and drugs suspected of being teratogenic. Thus, the computer readable storage media may serve to deny access to, dispensing of, or prescriptions for contraindicated drugs, including teratogenic drugs and drugs suspected of being teratogenic, to patients, pharmacies or prescribers who fail to abide by the methods of the present invention. As noted above, prescribers who are not registered in a computer readable storage medium generally may not prescribe the drug, and pharmacies who are not registered generally may not dispense the drug. Similarly, the drugs generally may not be prescribed and/or dispensed to patients who are not registered in a computer readable storage medium. In addition, patients may be required to present an informed consent form to the pharmacy. Unless such a form is presented to the pharmacy, or verification of such informed consent has been provided by the prescriber and registered in the computer readable media, the patient generally may not receive the prescription for the drug. As noted above, only limited amounts of the drug may be prescribed to the patient, with no refill prescriptions being permitted.

In certain embodiments of the invention, the methods may require that the registered pharmacy consult the computer readable medium to retrieve a prescription approval code before dispensing the drug to the patient. As used in this application, a “prescription approval code” is a code that refers not merely to a number that is associated with a prescription, but instead is a code that represents the fact that a determination has been made that the risk of the side effect occurring is acceptable, and that the approval—an affirmative decision—has been made for the prescription to be filled. This approval code is preferably not provided unless the prescriber, the pharmacy, the patient, the patient's risk group and the patient's informed consent have been properly registered in the storage medium. Additionally, depending upon the risk group assignment, generation of the prescription approval code may further require the registration in the storage medium of the additional set of information, including periodic surveys and the results of diagnostic tests, as have been defined as being relevant to the risk group assignment. Thus, to comply with the present methods and receive approval to dispense the drug as prescribed, the registered pharmacy need only retrieve the approval code. If the prescription approval code is not forthcoming, the patient may be directed to complete the necessary survey, for example, by telephone, or may be directed back to the prescriber for completion of necessary diagnostic tests. In this manner, the effort required by the pharmacy is minimized, and greater compliance with the present methods may efficiently and advantageously be achieved. Additionally, the embodiments described herein may provide greater assurance that all required further information, as is appropriate to the patient's risk group assignment, has been obtained before the drug is dispensed to the patient, and thereby minimize the risk that an adverse side effect will occur.

While the delivery of teratogenic drugs and drugs suspected of being teratogenic are an aspect of the present invention which has clearly apparent benefit, other types of drugs may also beneficially be prescribed and delivered in accordance with one or more embodiments hereof and all are contemplated hereby. For example, the methods of the present invention may be used for delivery of a drug which is known or suspected of causing liver damage in many patients who take the drug. One such drug is isoniazid, a widely known treatment for tuberculosis (TB). In following a method of the present invention, a registered physician may wish to prescribe isoniazid to a patient who has tested positive for TB. The physician may register the patient in a computer readable storage medium, along with certain information regarding the patient's age, medical condition, and so on. If the patient is a young adult, for example, and presents with no other complicating risk factors, the patient may be assigned to a risk group that is designated to receive counseling regarding certain behavior, such as the concomitant use of alcohol, which is to be avoided. The patient may be fully informed of the risks of liver damage that may result from taking isoniazid, and is preferably counseled to avoid drinking any alcoholic beverages while undergoing treatment with the drug. Preferably, the patient signs an informed consent form, and the prescribing physician transmits verification of the informed consent, along with the patient's registration form and risk group assignment to the computer readable storage medium. The physician then provides the patient with a prescription for the isoniazid. Upon presentation of the prescription to a registered pharmacy, the computer readable storage medium is consulted to verify that the patient and prescriber are registered therein, and that the patient's risk group assignment and informed consent have been provided.

If the patient's risk group assignment so indicates, certain diagnostic tests may additionally be required, so that baseline data may be obtained, before the prescription will be approved for filling. The patient's risk group may indicate, for example, that serum liver enzymes should be evaluated on a monthly basis. Under these circumstances, the prescription will preferably be filled for no more than about 30 days.

The patient will also preferably be advised that completion of a monthly survey will be required. This survey may include a questionnaire which is probative of the patient's alcohol consumption over the past month. The survey may also include questions which are probative of certain symptoms which may be indicative of the early onset of liver damage or other side effects known or suspected of being caused by isoniazid. Additionally, questions regarding the patient's concomitant use of other drugs which are known to be hazardous when taken in combination with isoniazid, may be asked. Preferably, this survey is conducted telephonically, using an integrated voice response system, and the responses are entered in the storage medium. Based upon the patient's responses, the patient's risk group assignment is adjusted or left the same, as may be appropriate.

The patient is preferably further instructed that periodic diagnostic testing may also be necessary for continued approval of a prescription. Preferably, the diagnostic testing will include an assay of the patient's serum liver enzyme levels, to screen for early signs of liver damage. Additionally, the diagnostic testing may include screens for the presence of other drugs known to also cause liver damage, or to be hazardous if taken in combination with isoniazid. A prescription approval code generally will not be generated for subsequent prescriptions or refills until such periodic tests have been performed and satisfactory results entered into the computer readable storage medium. If a prescription approval code is not received by the pharmacy, the patient is directed to complete the requisite survey or tests, or to return to the doctor for further consultation.

If the test results or survey indicate that the risk of liver damage has increased, the patient's risk group assignment may be changed, or the patient will be directed to consult with the prescriber before any further isoniazid may be dispensed. In this way, the development of the adverse side effect of concern may be monitored. For example, if the tests indicate that some liver enzymes are marginally elevated, the patient's risk group status may be changed from a first risk group to a second risk group. As a member of this second risk group, the patient may be required to undergo additional diagnostic testing before approval will be given to receive the drug. Such testing may include, for example, liver function tests, to further diagnose the level of cellular damage potentially being caused by the isoniazid, or the combination of isoniazid and other drugs, such as alcohol. In more extreme cases, a diagnostic ultrasound of the liver, or even a liver biopsy may even be indicated. Ultimately, if the risk of continued administration becomes so great that it outweighs the possible benefits of continued treatment with isoniazid, the patient may be assigned to a risk group which indicates that the drug may no longer be dispensed to that patient.

The methods of the present invention may similarly be employed, for example, where the patient is undergoing treatment for infection with the Human Immunodeficiency Virus (HIV). Patients who test positive for HIV may be treated with one or more drugs to combat the onset of the Acquired Immune Deficiency Syndrome (AIDS). Frequently, HIV positive patients are administered an “AIDS cocktail” of several drugs including, for example, a combination of one or more inhibitors of viral protease and reverse transcriptase. By following the methods of the present invention, the patient may continue to receive the combination of drugs, while the risk of adverse side effects from administration of the drugs may be minimized. Additionally, the methods of the present invention may be desirably and advantageously used to educate and reinforce the actions and behaviors of patients who are taking a drug, as well as prescribers who prescribe the drug and pharmacies which dispense the drug.

As with methods of the invention previously described, when a patient has tested positive for HIV, a registered prescriber may obtain background information on the patient and see that a registration form is completed so that the patient may be registered in the computer readable storage medium. The prescriber may prescribe one or more drugs to the patient, including drugs which may be known or suspected of causing adverse side effects, either alone or in combination with each other or with other drugs. Depending upon the drugs prescribed, and also upon information which the prescriber will preferably obtain regarding the patient's medical history, physical condition and lifestyle, the patient will preferably be assigned to at least one risk group. Based upon this risk group assignment, the patient will preferably receive educational materials and counseling regarding the risks associated with the prescribed drugs, and be advised of the importance of the treatment regimen. The patient will also preferably receive counseling regarding the risk of spreading the disease to others, including a foetus which may be carried by the patient and any recipient of a bodily fluid of the patient. Thus, the patient may be counseled regarding the preferential use of one or more methods of birth control, and may also be provided with a contraceptive device by the prescriber. Additionally, the patient will preferably be counseled not to share any of the drugs with others, and to avoid taking any medications not prescribed. In this way, the patient will preferably be counseled both as to methods for minimizing the spread of the disease, as well as to methods for avoiding the occurrence of one or more side effects which may result from the taking of the medication. Preferably, upon full disclosure of all risks inherent in the treatment regimen, the prescriber will obtain and register in the computer readable storage medium the informed consent of the patient to receive the medication and to comply with the methods described herein for avoiding the occurrence of one or more side effects which may result from taking the drug or drugs prescribed.

To facilitate compliance with the methods of the present invention, and to minimize the likelihood of the occurrence of a known or suspected adverse side effect from treatment with the prescribed drug or drugs, it is preferable that when prescriptions for the drug are presented to a registered pharmacy, the computer readable storage medium is consulted to retrieve a prescription approval code before the drug is dispensed to the patient. In order for a prescription approval code to be generated, and based upon the patient's risk group assignment, the patient may be required to provide additional information, which may then be entered in the storage medium before approval of the prescription may be provided. For example, the patient may be required to undergo certain diagnostic tests. In a patient with HIV, for example, testing for viral load may be required, both initially and on a periodic basis, so that dosing of the medication may be adjusted, as necessary. The patient may also be required to complete a survey which asks questions probative of the likelihood that the patient is taking other medications, or beginning to exhibit symptoms which may be of importance to the selection and implementation of a therapeutic regimen. Such additional information may be required both before the initiation of treatment and on a periodic basis during treatment, as new prescriptions and prescription refills are generated. Based upon the information provided by the patient, and the results of any diagnostic tests which have been performed, the patient's risk group assignment may stay the same, or may be changed, as indicated. The patient's risk group assignment may also be changed based upon the length of time the patient has been receiving a given drug or medication.

A periodic patient survey may serve both to remind the patient of the requirements of the drug distribution program, and to obtain information which may be probative of the risk that an adverse side effect may occur. For example, the survey may include questions probative of the patient's behavior as it relates to the sharing of medication with other HIV positive individuals, and the patient's compliance with measures for avoiding the spread of the disease. Additionally, the survey may include questions regarding other drugs, medications or treatments which the patient might be availing themselves of, which would impact the risk of an adverse side effect occurring.

The survey may also contain questions which are probative of the onset of certain symptoms which may be indicative of the need for changes in the patient's treatment regimen. For example, some questions may be probative of the onset of depression in the patient, a common occurrence amongst AIDS sufferers. Answers to questions in the survey that are indicative of depression, for example, may cause the patient's risk group assignment to change such that the patient is directed to return to the prescriber for determination of whether treatment with an anti-depressant drug is indicated. Similarly, certain drugs, such as protease inhibitors, for example, may lead to abnormal redistribution of fat in certain patients. This symptom may be seen in conjunction with certain metabolic defects and may in turn be symptomatic of conditions such as high blood sugar and high cholesterol. Questions relating to this abnormality may be included on the survey, and answers which indicate that the patient has noticed such physical changes may lead to the assignment of the patient to a risk group in which diagnostic tests probative of the metabolic abnormalities are required before further access to the drug in question is permitted.

As with the survey, the diagnostic testing which the patient may be required to undergo may vary with, and preferably is appropriate to, the patient's risk group assignment. In addition to testing for the patient's viral load, periodic diagnostic testing may be appropriate, for example, to evaluate the level of one or more medications in the patient. Dosage of reverse transcriptase inhibitors, for example, may be critical to the risk of occurrence of an adverse side effect. At the same time, various drugs which are often used in combination may share similar metabolic pathways, so that the addition of a second drug to the treatment regimen may greatly affect the pharmacokinetics of the first drug, thereby necessitating an adjustment in the dose of the first drug. In the case of treatment with an “AIDS cocktail” containing, for example, the use of ritonavir, a well-known protease inhibitor, may greatly impact the bioavailability of other protease inhibitors, requiring that the dose of the other protease inhibitors be reduced. Accordingly, the inclusion of ritonavir in the patient's treatment regimen may initiate a change in risk-group assignment, which in turn requires that diagnostic testing to evaluate the blood levels of other concomitantly administered protease inhibitors be done on a periodic basis.

Similarly, the addition of other drugs to the treatment regimen, either by the prescribing physician, or by another physician whom the patient might visit, may interfere with the initial treatment regimen prescribed by the registered prescriber. For example, AIDS patients often develop mycobacterial infections such as tuberculosis. An infectious disease specialist may prescribe one of a class of drugs known as rifamycins, such as rifampin or rifabutin, to treat such infections. Rifamycins are known to accelerate the metabolism of many protease inhibitors, however, so that upon initiation of treatment with a rifamycin, the effectiveness of the protease inhibitors may be greatly reduced, unless the dosage of those drugs is adjusted appropriately. Thus, when the patient is being treated with a protease inhibitor, the survey may include, for example, questions regarding the possible concurrent use of a rifamycin. If the survey results indicate that the two types of drugs are being used concurrently, the patient's risk group assignment is changed, such that the patient may be referred back to the prescriber for an adjustment in dosage, or the patient may be directed to undergo diagnostic testing to assure that a sufficient level of the protease inhibitor is still being maintained. Similarly, where the registered prescriber adds a prescription for a rifamycin to the treatment regimen of a registered patient who is also receiving a protease inhibitor, entry of the prescription into the computer readable storage medium may trigger an automatic change in risk group assignment, such that approval of the prescription will not be generated without further modification of the dosage of the protease inhibitor. In this way, the methods of the present invention may be advantageously utilized to maintain the proper dosing of one or more drugs, to minimize the likelihood of the occurrence of an adverse side effect from the concomitant use of such drugs, or the addition of other drugs to a treatment regimen, to encourage proper disclosure of the risks associated with the taking of one or more drugs, to minimize the risk that a contraindicated individual will be exposed to the potentially hazardous drugs, and to assist in generating patient compliance with treatment protocols and avoidance of behavior known to increase the risk that the disease will be spread to others.

In other embodiments of the present invention, the methods disclosed herein may be employed, for example, where a patient is undergoing treatment for various diseases, disorders or conditions, including, for example, transfusion dependent anemia due to Low- or Intermediate-1-risk myelodysplastic syndromes (MDS) associated with a deletion 5q chromosomal abnormality with or without additional cytogenetic abnormalities and multiple myeloma. Such patients may be treated with a drug, including a tertatogenic, suspected teratogenic, or other hazardous drug, such as, for example, lenalidomide or thalidomide. In certain embodiments, patients undergoing treatment for multiple myeloma may be treated with lenalidomide or thalidomide in combination with another drug, such as, for example, dexamethasone, where the patient has received at least one prior therapy for multiple myeloma. By following the methods of the present invention, the patient may be authorized to receive and continue to receive lenalidomide or thalidomide, while the risk of adverse side effects from administration of lenalidomide or thalidomide may be minimized or avoided. Additionally, the methods of the present invention may be desirably and advantageously used to educate and reinforce the actions and behaviors of patients who are taking lenalidomide or thalidomide, as well as prescribers who prescribe the drug and pharmacies which dispense the drug.

In addition to the methods described above, in certain embodiments of the present invention, the delivery of lenalidomide or thalidomide to the patient may involve the following steps. To control the distribution of lenalidomide or thalidomide and minimize the risk that a patient will receive the drug who is not eligible to receive it, or minimize the risk that an adverse side effect will occur from taking it, lenalidomide or thalidomide will preferably only be available through a controlled distribution program, as described above for teratogenic, suspected teratogenic, or other hazardous drugs and as further exemplified below. Under this program, as a prelude to prescribing and dispensing the drug to the patient, the prescriber, pharmacy, and patient are registered in one or more appropriate computer readable storage media, as described above. If the prescriber is not registered in the computer readable storage medium, the prescriber will be ineligible to prescribe the drug. Similarly, if the pharmacy is not registered in the computer readable storage medium, the pharmacy will be ineligible to dispense the drug. Likewise, if the patient is not registered in the computer readable storage medium, he or she will be ineligible to receive the drug.

As with the methods of the present invention previously described, prior to a patient receiving a prescription for lenalidomide or thalidomide, the patient must receive counseling about the drug, including counseling, for example, on effective birth control, and the risks of developing cytopenias, pulmonary embolisms, and deep venous thrombosis, if applicable. In some embodiments, patient counseling will be performed by the physician. In other embodiments, patient counseling will be performed by both the physician and the pharmacist. The methods of the present invention preferably involve requiring the patient to fill out an informed consent form which is signed by the prescriber as well as the patient. The prescriber should retain a copy of the informed consent form for his/her records. Verification that the patient has given his/her informed consent may also be registered in the computer readable storage medium. Preferably, this verification is provided by the prescriber, and may be included, for example, with the patient registration information and risk group assignment. It has surprisingly been found that by having the prescriber, rather than the pharmacy, verify the patient's informed consent, the methods of the present invention may operate more efficiently, leading to better compliance, and hence decreased risk that the adverse side effect will occur, may be achieved. The patient will also receive counseling on the risks associated with taking the drug. Such counseling may be conducted verbally or may be in written form. In some embodiments, the patient will be supplied with training materials, including, for example, the informed consent form, a medication guide, product information, product package inserts, educational brochures, a pamphlet describing the patient surveys, and information on emergency contraception. The training materials preferably will contain a drug supply log form for the patient to record the date and quantity of drug received. The training materials may also provide the patient with information from which to he or she can educate his or her spouse or partner on the risks associated with taking the drug and need to comply with proper dosing regimens.

With respect to counseling, in certain embodiments, a third party vendor may confirm through consultation of answers to initial and follow-up surveys that proper counseling occurred every 28 days. Generally speaking, in certain embodiments, completed surveys will be faxed to the third party vendor, who then confirms the answers and supplies a confirmation number, as described below, to a physician to write on the prescription. Alternatively, if the third party vendor determines that the answers to the survey are incomplete or indicate that the patient is ineligible to receive the drug, the third party vendor will contact the physician to cancel the patient's prescription. As another alternative, the survey may be conducted using an integrated voice response system wherein the third party vendor confirms the survey answers and supplies a confirmation number as described below, to a physician to write on the prescription.

By filling out and signing an informed consent form, the patient acknowledges that he or she understands the risks associated with taking lenalidomide or thalidomide. In the informed consent form, the patient preferably agrees to comply with the risk avoidance measures provided, and to behave in a manner which is consistent with the prescriber's counsel. In certain embodiments, by signing the informed consent form, the patient acknowledges his or her consent to participate in one or more clinical trials regarding distribution of the drug. In certain embodiments of the present invention, by signing the informed consent form, the patient also acknowledges that he or she has informed his or her partner or spouse that the patient is taking lenalidomide or thalidomide, that the patient has been provided education materials (said materials preferably available in a language of a patient's choice such as, for example, Arabic, Cambodian, Chinese, English, French, German, Greek, Italian, Japanese, Korean, Laotian, Polish, Portuguese, Russian, Spanish, or Vietnamese) about the risks associated or suspected with lenalidomide or thalidomide therapy and precautions necessary to prevent fetal exposure by both the patient and the spouse during lenalidomide or thalidomide therapy to the partner or spouse, and that the patient has discussed effective birth control options with the partner or spouse.

In certain embodiments of the present invention, by filling out and signing the informed consent form, the patient also acknowledges that he or she agrees to designate and/or educate a drug accountability person to act on his or her behalf. As used herein, the term “drug accountability person” refers, for example, to a family member, friend, or guardian of the patient, or nurse assisting the patient, who is educated on the risks associated with taking lenalidomide or thalidomide, including the risks that lenalidomide or thalidomide may cause human birth defects or death to an unborn baby and that appropriate birth control must be used, the risk of developing deep venous thrombosis and pulmonary embolisms, and for MDS patients, the signs and symptoms of cytopenias (including neutropenia and/or thrombocytopenia) and the need for routine blood tests.

As with the patient, the drug accountability person will preferably be registered in the computer readable storage medium, including, for example, the drug accountability person's name, address, phone number, and relationship to the patient. The drug accountability person will be educated on the risk associated with lenalidomide or thalidomide therapy, including the risks that lenalidomide or thalidomide may cause human birth defects or death to an unborn baby and that appropriate birth control must be used, the risk of developing deep venous thrombosis and pulmonary embolisms, and for MDS patients, the signs and symptoms of cytopenias (including neutropenia and/or thrombocytopenia) and the need for routine blood test. In some embodiments, the drug accountability person signs an informed consent form indicating that he or she has received counseling regarding the risks associated with lenalidomide or thalidomide therapy and that he or she agrees to assist the patient in taking lenalidomide or thalidomide consistent with prescription guidelines, assist in the patient in preventing diversion of the drug, assist the patient in returning the drug to a pharmacy, distributor, or manufacturer of the drug if the drug is no longer suitable for the patient, and/or to return the drug to a pharmacy, distributor, or manufacturer of the drug if the patient expires prior to using all of the drug. In some embodiments, it is contemplated that a patient may be unable to designate a drug accountability person. In such circumstances, the prescriber may determine whether the patient is eligible to receive the drug in the absence of designating a drug accountability person.

Preferably, lenalidomide or thalidomide will be distributed by an entity through contract pharmacies. In certain embodiments, only a pharmacy that has contracted with the distributor or manufacturer of the drug will be eligible to dispense the drug.

It is preferred that prescriptions for lenalidomide or thalidomide are faxed to the contract pharmacy or delivered in person. As used herein, the term “contract pharmacy” refers to a pharmacy that has contracted to distribute lenalidomide or thalidomide. In certain embodiments, a contract pharmacy may be located at an academic medical center, a prison or correctional facility, a Health Maintenance Organization (“HMO”), or a governmental body or agency, such as, for example, the Department of Defense. In addition to the eligibility requirements described above for teratogenic, suspected teratogenic, or other hazardous drugs, pharmacists and/or nurses employed by such contract pharmacies will preferably be trained on how to educate and counsel patients on risk avoidance measures associated with lenalidomide or thalidomide therapy. In certain embodiments, pharmacists and/or nurses employed by such contract pharmacies will be certified by an entity to counsel patients and dispense lenalidomide or thalidomide. Pharmacists and/or nurses will be required to participate in training programs, including review of training modules that provide an overview of MDS and multiple myeloma. Pharmacists and/or nurses will also be required to attend didactic or web-based training programs prior to being authorized to dispense lenalidomide or thalidomide. In circumstances where a patient is counseled on the risks of taking lenalidomide or thalidomide by both the prescriber and pharmacist and/or nurse, the pharmacist and/or nurse will preferably educate patients on risk avoidance measures associated with lenalidomide or thalidomide therapy, as described below.

As described previously with respect to teratogenic, suspected teratogenic, or other hazardous drugs, information will preferably be collected from the patient that may be probative of the risk that a known or suspected side effect may occur if lenalidomide or thalidomide is taken by the patient. This information may then be compared with a predefined set of risk parameters for the lenalidomide or thalidomide, which in turn define a plurality of risk groups, so that analysis of the information will permit assignment of the patient to at least one of the risk groups. Preferably, this risk group assignment is then also entered into the computer readable storage medium. This assignment may be performed by the prescriber, who may then include the risk group assignment on the patient's registration card or form, or may be performed by another individual, such as a nurse, technician, office personnel, or pharmacist, who preferably interprets the information and assigns the patient to one of the risk groups, accordingly.

As discussed above, it is preferable that a plurality of risk groups, each based upon a predefined set of risk parameters, be established for lenalidomide or thalidomide. With respect to lenalidomide or thalidomide, for example, a first risk group may comprise adult females of child-bearing potential; a second risk group may comprise adult females not of child-bearing potential; a third risk group may comprise female children of child-bearing potential; a fourth risk group may comprise female children not of child-bearing potential; a fifth risk group may comprise adult males; and a sixth risk group may comprise male children.

As used herein, the term “female of child-bearing potential” refers to a sexually mature female who has not undergone a hysterectomy or bilateral oopherectomy, and who has not been naturally post-menopausal for at least twenty-four consecutive months. In certain embodiments, in order for a female of child-bearing potential to be eligible to receive a drug, she must agree, for example, to completely abstain from sexual intercourse, or to use two methods of effective birth control simultaneously for four weeks prior to beginning therapy with the prescribed drug, during therapy, during therapy interruptions, if any, and for four weeks after completion of therapy.

As used herein, the term “effective birth control” refers to the combination of at least one highly effective method of birth control with another highly effective method or an effective barrier method of birth control used simultaneously. As used herein, the term “highly effective method of birth control” refers to an intrauterine device, a hormonal method, such as pills, patches, injections, implants or rings, tubal ligation, and a partner's vasectomy. As used herein, the term “effective barrier method of birth control” refers to a male latex condom, cervical cap, and diaphragm.

Preferably, before a female of child-bearing potential is eligible to receive lenalidomide or thalidomide, she must have a negative pregnancy test, with a sensitivity of at least 50 mIU/ml, prior to receipt of her first prescription for lenalidomide or thalidomide, within 10 and 14 days prior to the first prescription, and within 24 hours of the first prescription. During the first month of therapy, females of child-bearing potential preferably must also have negative pregnancy tests weekly for four weeks. Preferably, after the first month of therapy, females of child-bearing potential will receive monthly pregnancy tests, if she has regular menses, or twice monthly pregnancy tests if menses is irregular. In addition, if a patient misses her period, or has unusual menstrual bleeding during therapy, treatment with lenalidomide or thalidomide should preferably be discontinued and the patient should consult with her physician. In one embodiment, before receiving a prescription for lenalidomide or thalidomide, the prescriber confirms that the patient is not pregnant. In another embodiment, before receiving a prescription for lenalidomide or thalidomide, the prescriber and the pharmacist confirm that the patient is not pregnant.

Preferably, all female patients must refrain from breastfeeding and donating blood during lenalidomide or thalidomide therapy and for four weeks after completing therapy. All female patients must agree not to share the drug with anyone and must participate in mandatory, confidential surveys.

Preferably, a male patient must agree to use latex condoms every time he has sexual intercourse with a female of child bearing potential and for four weeks after completing lenalidomide or thalidomide therapy, even if he has undergone a successful vasectomy. Male patients must also agree to tell his healthcare provider if he has sexual intercourse without using a latex condom and if his partner may be pregnant. In addition, male patients must refrain from donating blood or sperm during therapy and for four weeks after completing therapy. All male patients must agree not to share the drug with anyone.

Preferably, for non-adult patients, i.e., children under the age of 18, the parent or guardian of the patient, will receive education and counseling about the risks associated with the drug, and instructions not to share the drug with anyone. For sexually active children, the pharmacist and/or physician should preferably discuss birth control options with the patient and parent or guardian of the patient as described above for adult patients. For non-sexually active children, the parent or guardian must agree to notify the healthcare provider, including the prescriber or pharmacist, if a female patient begins menses.

Preferably, for an incompetent adult patient, an authorized representative must receive education and counseling about the risks associated with the drug, and instructions not to share the drug with anyone on behalf of the incompetent adult patient. The authorized representative may be, for example, a relative, spouse, family member, friend, guardian, or caretaker who is authorized under applicable state laws to consent to treatment on the incompetent patient's behalf. The authorized representative must read all educational material, initial the informed consent forms, and agree to ensure compliance. For incompetent adult patients, the prescriber must also submit a signed and dated letter on the prescriber's letterhead, stating that the incompetent patient lacks the capacity to complete the informed consent form, identifying the medical condition causing the incapacity, the name and address of the authorized representative and relationship to the patient, and an opinion that the authorized representative accepts responsibility for the patient's compliance with the program and is authorized to consent to treatment on the patient's behalf.

All patients will preferably be counseled to use appropriate contraception to prevent fetal exposure to the drug. In addition, patients will preferably be counseled on the risks of developing neutropenia and thrombocytopenia from lenalidomide treatment (or other treatment) for MDS. Such patients will preferably get complete blood counts (CBCs) weekly during the first eight weeks of therapy and at least monthly thereafter.

In certain embodiments, patients may be assigned to an obstetrician/gynecologist (“OB/GYN”). In such cases, the OB/GYN may provide additional counseling to the patient regarding contraceptive measures. In certain cases, the OB/GYN may provide emergency contraception to a patient taking lenalidomide or thalidomide who thinks she may be pregnant or to a woman who may have been impregnated by a male patient taking lenalidomide or thalidomide. If an OB/GYN is designated for a patient, the OB/GYN may be registered in a computer readable storage medium. Registration may include the OB/GYN's name, address, and affiliation, if any, with one or more health care institutions. In certain embodiments, the prescriber will identify an OB/GYN for the patient to handle patient inquires concerning, for example, emergency contraception, additional patient counseling, pregnancy testing, and positive pregnancy results.

In certain embodiments of the invention, counseling may be undertaken by a pharmacist, doctor, nurse, or other health care professional at a contract pharmacy, either by phone or in person.

For patients being treated with lenalidomide (or another drug) for multiple myeloma, patients may optionally get CBCs every two weeks for the first twelve weeks of treatment and then monthly thereafter. Such patients should preferably be counseled on the risk of developing deep venous thrombosis and pulmonary embolism. All patients should be counseled not to share lenalidomide (or another drug) with anyone.

In certain embodiments, pharmacists and/or nurses will preferably contact patients who have been prescribed lenalidomide or thalidomide prior to shipping or filling a prescription for it. During this phone or in-person contact, patients will preferably be counseled, as describe above, that lenalidomide or thalidomide may cause human birth defects or death to an unborn baby, appropriate birth control must be used, the risk of developing deep venous thrombosis and pulmonary embolisms, and for MDS patients, the signs and symptoms of cytopenias (including neutropenia and/or thrombocytopenia) and the need for routine blood tests. Prior to dispensing lenalidomide or thalidomide, the pharmacist or nurse will confirm that the patient understands the risks of the drug. The pharmacist or nurse will also verify the patient's shipping address, if necessary. Preferably, the pharmacist does not ship or dispense lenalidomide or thalidomide to a patient until an authorization number is verified and a confirmation number is issued to the pharmacist, and the pharmacist or nurse has counseled the patient, as described above.

As used herein, the term “authorization number” refers to a number issued to the physician after the completion of patient counseling by the physician, the patient survey by the patient, and the physician survey by the physician. Once the physician obtains the authorization number, it is written on the prescription. In certain embodiments, the authorization number is valid only for a limited time starting from the day the physician obtains the authorization number, such as, for example, seven or 14 days for females of child-bearing potential, or 14 days for patients not of child-bearing potential. In certain embodiments, in addition to the authorization number, the physician will also be issued a “must ship/dispense by date,” which is preferably also written on the prescription. The “must ship/dispense by date” refers to the date by which a pharmacy must either counsel the patient as to the risks associated with the prescribed drug, as discussed above, and ship the drug to the patient; or counsel the patient as to the risks associated with the prescribed drug, as discussed above, and dispense the drug to the patient.

As used herein, the term “confirmation number” refers to a verification number that a marketer or distributor of a drug preferably provides to the pharmacist when the pharmacist calls or otherwise contacts, including via on-line or web-based transmission, a marketer or distributor to verify the authorization number. The confirmation number may also be supplied by a third party vendor to the physician after verifying patient compliance through survey answers. Preferably, the confirmation number is valid for 24 hours after the pharmacist or physician obtains the confirmation number. In preferred embodiments, the pharmacy ships or provides lenalidomide or thalidomide within the time the confirmation number is valid (i.e., within 24 hours). If the drug is not shipped or picked up within the 24 hour time frame, the pharmacy will cancel the confirmation number and obtain a new confirmation number when it is ready to ship the drug or have it picked up. In certain embodiments, when the pharmacist contacts a marketer or distributor to verify the authorization number, the pharmacist receives, in addition to the confirmation number, an indication as to the number of days the prescription is valid for, such that the pharmacist is informed of the of the number days remaining in which the prescription can be filled.

Prior to being provided a confirmation number, in certain embodiments the pharmacist must confirm that the pharmacy has the drug in stock and ready to dispense. If the pharmacy does not currently have the drug in stock at the time that the pharmacist seeks to obtain the confirmation number, a confirmation number will not be provided and the pharmacy will not be authorized to dispense the drug.

The pharmacy may seek to obtain supply of the drug. It is contemplated that a pharmacy may request transfer of the drug to it from another pharmacy. In certain embodiments, a retail pharmacy that is a member of a chain of pharmacies may request that the drug be transferred to it from another pharmacy that is apart of the same pharmacy chain. The drug can then be shipped or otherwise transferred to the pharmacy that seeks to dispense it. Preferably, the drug transferred is from the transferor-pharmacy's most recently received inventory.

Alternatively, a pharmacy may request transfer of the drug to it from any other pharmacy. Preferably, the drug transferred is from the transferor-pharmacy's most recently received inventory. In other embodiments, the drug transferred is from the transferor-pharmacy's stored inventory.

In certain embodiment, lenalidomide, thalidomide or other hazardous drug will be distributed and dispensed through an exclusive central pharmacy. In such cases, the central pharmacy will act in place of the contract pharmacy, and in addition to the role described for the contract pharmacy, will contact the prescriber to verify the prescriber's eligibility to prescribe the drug. The central pharmacy will also perform patient counseling on the risks of taking the drug and risk avoidance measures. The central pharmacy will preferably ship the drug to the patient's home and will confirm by follow-up telephone call that the drug has been received by the patient.

It certain embodiments, it may be preferable to educate a patient as to the existence of one or more pharmacies registered to dispense the teratogenic, suspected teratogenic, or other hazardous drug. Registered prescribers may be supplied with a list of registered pharmacies, which list may then be supplied to the patient. In certain embodiments, the list of registered pharmacies may include, for example, those pharmacies that are located within 15 miles or less to the prescriber and/or patient. In other embodiments, the list of registered pharmacies may include, for example, those pharmacies located within the same state, region, or territory as the prescriber and/or patient. In other embodiments, the list of registered pharmacies may include, for example, those registered pharmacies that have dispensed the teratogenic, suspected teratogenic, or other hazardous drug within the preceding 12 months. Still in other embodiments, the list of registered pharmacies may include, for example, all registered pharmacies. One skilled in the art will readily appreciate that a list of registered pharmacies may include a list of pharmacies in any or all of the foregoing categories.

As noted above for other teratogenic drugs and drugs suspected of being teratogenic, lenalidomide or thalidomide is preferably prescribed and dispensed to the patient in a limited amount, with a prescription amount of no more than about 28 days being preferred, and preferably with no refills being permitted. Preferably, a new prescription is required for subsequent dispensations of the drug and a subsequent prescription will not be dispensed unless there are seven days or less remaining on the current prescription. Thus, for the patient to obtain an additional prescription, it is generally necessary for the patient to have a follow-up visit with the prescriber. Such a follow-up visit preferably takes place at least each time the patient requires a renewal of the prescription, and possibly more often if the patient requires, for example, additional counseling. At the follow-up visit, the patient will preferably receive additional counseling regarding the risks and benefits associated with taking the drug, as well as further counseling on birth control (if applicable). The patient will also preferably complete an additional patient survey to provide current information regarding their lifestyle, including their sexual behavior and, if female of childbearing potential, be administered a new pregnancy test. In some embodiments, certain patients may need only complete a follow-up survey after every six months of therapy. Such patients may include males and females of non-child bearing potential. The additional patient survey may be administered to the patient in a variety of ways, including by telephone, by facsimile, through the use of an integrated voice response system, and/or through a web-based system. After receiving the counseling and completing the patient survey, and if the pregnancy tests for female patients are negative, the prescriber may fill out a new prescription for the drug. As with the original prescription, the renewal prescription is preferably for a limited period of time, with no more than about 28 days being more preferred. If the survey results reveal that the patient is not complying with the prescribing guidelines, preferably a representative from a marketer or distributor of a drug, will contact prescriber and inform the prescriber of the survey results. If therapy is discontinued for twelve consecutive months, in order for the patient to receive a new prescription for lenalidomide or thalidomide, he or she must re-register in the program as previously described.

It is to be appreciated, of course, that one or more of the methods of the present invention may be accomplished by means of one or more computer systems. Accordingly, in certain embodiments, the invention comprises a computer system capable of automating one or more steps of the methods disclosed herein. Such a computer system may comprise, in certain embodiments of the invention, one or more of an input/output means, means for storing data regarding the patient, the prescriber, and the drug, means for communicating data over an internal or external network, means for communicating data over the internet, and means (interactive, in certain embodiments) for providing patient, prescriber, or drug accountability person with education regarding a drug or a drug's safe and effective use.

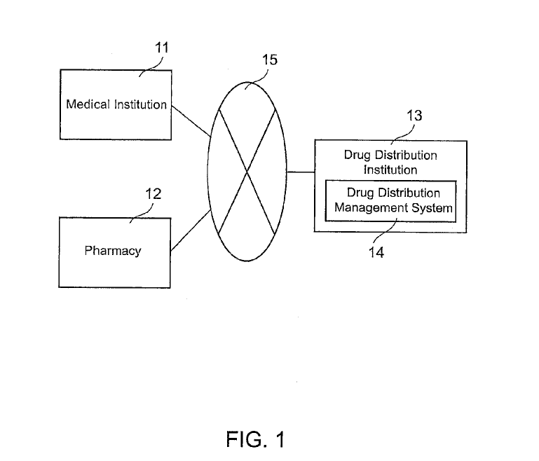

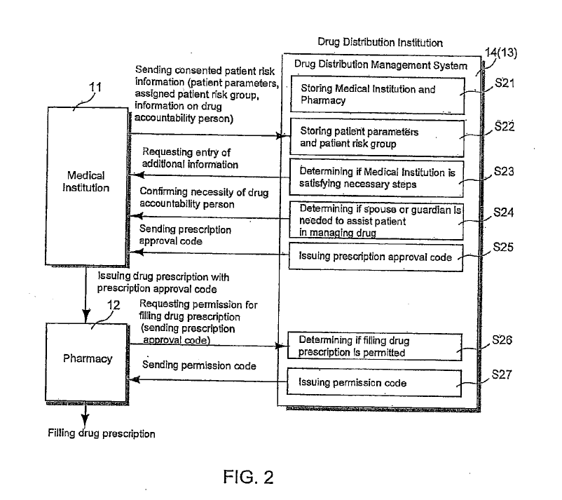

In other embodiments, and as illustrated by FIG. 1 to FIG. 3, the invention comprises a drug distribution management system located at a distributor side for managing the distribution of a drug which has a potential risk of an adverse side effect. The system is described below with reference to FIGS. 1 and 2.

FIG. 1 is a diagram that illustrates an embodiment of the invention where a medical institution 11, a pharmacy 12, and a drug distribution institution 13 are interconnected through network 15. The network 15 may be a Wide Area Network (WAN) such as Internet and a telephone network (a FAX transmission), or a closed local network using a dedicated line, or the combination thereof.

Operation and Effect of the System

In this embodiment, a system 14 located at the drug distribution institution 13 receives information from the medical institution 11 and the pharmacy 12 to store it into a computer readable medium, and then, processes the information received from the medical institution 11 and the pharmacy 12 to generate a prescription approval code and a permission code for filling a drug prescription. Generation of such prescription approval code and permission code for filling a drug prescription by the system 14 enables a safe distribution of a drug having a potential risk of an adverse side effect.

Thus, the system 14 at the distributor side utilizes a computer, and as shown in FIG. 2, the system performs the steps of:

(step 21, “S21”) receiving information of the medical institution 11 and the pharmacy 12, the information is stored in a storage medium of the system 14;

(step 22, “S22”) receiving from the medical institution 11, a predefined set of parameters on a specific patient and information on assignment of the patient to a risk group, where the predefined set of parameters and the information on assignment is stored in a storage medium of the system 14;

(step 23, “S23”) determining based on the parameters from the medical institution 11 whether requirements for the patient to be assigned to the risk group are satisfied, and if the requirements are not satisfied, issuing an alert for the assigned patient risk group to be reviewed;

(step 24, “S24”) based on the parameters from the medical institution 11, determining with a predefined definition whether registration of the spouse of the patient, designated family member, or guardian is needed to assist the patient in taking the drug, and if the registration of the spouse, designated family member, or guardian is not included in the parameters despite such registration being required, issuing an alert to request the medical institution 11 to enter a consent for such registration;

(step 25, “S25”) determining whether a prescription approval code is to be issued or denied based on a classification of said risk group and a decision on whether the registration of the spouse, designated family member, or guardian is required, and if said prescription approval code is determined to be issued, issuing the prescription approval code in association with the patient; and

(step 26, “S26”) receiving from the pharmacy 12 qualified to fill a prescription for the drug, an application for filling a prescription for the drug along with the prescription approval code, whereby issuing a permission code for filling the prescription for the drug based on the prescription approval code that confirms the authenticity of the application and the information that the pharmacy 12 is registered in the storage medium of the system 14.

The Structure

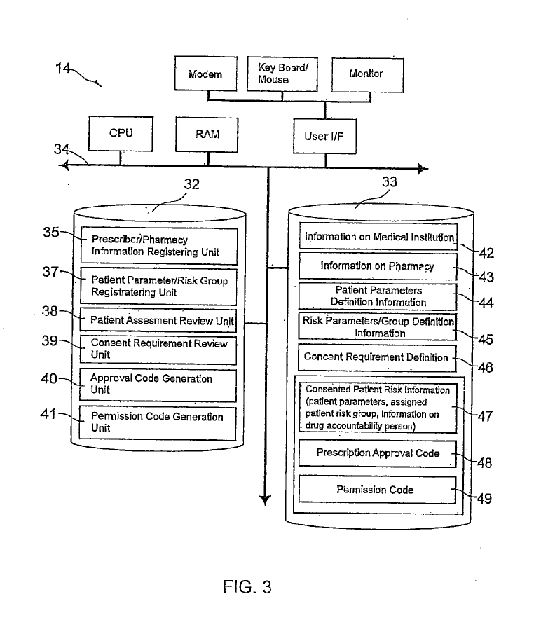

FIG. 3 illustrates a diagram that shows the structure of the system 14. The system 14 comprises a software program storage section 32 and a data storage section 33 that are logically connected to a communication bus 34 to which a CPU, a RAM and user I/F are connected. The software program storage section 32 comprises: a prescriber information/pharmacy information registering unit 35, a patient parameter/risk group registering unit 37, a patient assessment review unit 38, a consent requirement review unit 39, Approval code generation unit 40, and permission code generation unit 41. These units 35, and 37 to 41 are in fact software program modules, and they are adapted to function as each component of the present invention by being retrieved by the CPU on the RAM for execution.

The prescriber/pharmacy information registering unit 35 performs the step 21 of FIG. 2. That is, the prescriber/pharmacy information registering unit 35 receives information of the medical institution 11 and the pharmacy 12, and then the information is stored in the data storage section 33 of the system 14 (as shown with numeral reference numerals 42 and 43 in FIG. 3).

The patient parameter/risk group registering unit 37 performs the step 22 of FIG. 2. That is, the patient parameter/risk group registering unit 37 receives from the medical institution 11, a predefined set of parameters on a specific patient and information on assignment of the patient to a risk group. The patient parameter/risk group registering unit 37 stores the predefined set of parameters and the information on assignment (as shown with reference numeral 44) into data storage 33.

The patient assessment review unit 38 performs the step 23 of FIG. 2. That is, the patient assessment review unit 38 determines based on the parameters from the medical institution 11 whether requirements for the patient being assigned to a risk group are satisfied. This determination is performed based on the definitions (as shown with reference numbers 44 to 46) stored in the data stored section 33 and if the requirements are not satisfied, the system 14 issues an alert for the assigned patient risk group to be reviewed. The alert can be directly sent to the medical institution 11.

The consent requirement review unit 39, determines, based on the parameters from the medical institution 11, with a predefined definition (as shown with reference numbers 44 to 46) stored in the data storage section 33, whether registration of the spouse of the patient, designated family member, or guardian is needed to assist the patient in taking the drug, and if the registration of the spouse, designated family member, or guardian is not included in the parameters despite such registration being required, issuing an alert to request the medical institution 11 to enter a consent for such registration.

Approval code generation unit 40 determines whether a prescription approval code is to be issued or denied based on a classification of said risk group and a decision on whether the registration of the spouse, designated family member, or guardian is required, and if said prescription approval code is determined to be issued, issuing the prescription approval code in association with the patient. The issued approval code is stored in the data storage section 33 in association of the consented patient information 46.

Permission code generation unit 41 receives from a pharmacy 12 qualified to fill a prescription for the drug, an application for filling a prescription for the drug along with the prescription approval code, whereby issuing a permission code for filling the prescription for the drug based on the prescription approval code that confirms the authenticity of the application and the information that the pharmacy 12 is registered in the system 12. The issued permission code is stored in the data storage section 33 in association of the consented patient information 46.

Operation of the System

The system structure of the invention is described below in detail with reference to the operation of the system.

As explained above, the manufacture or subscriber of the drug conducts, registering in this system 14 information of prescribers 11 (medical institution 11) who are qualified to prescribe the involved drug, including, for example, teratogenic drugs. Once registered in the system 14, the system 14 recognizes that the prescriber 11 may be eligible to prescribe the drug to patients in need of the drug. Generally speaking, in order to become registered in the system 14, the prescriber 11 may be required to comply with various aspects of the methods described herein including, for example, providing patient education and counseling, and the like, as described in detail below. The registration of the prescriber 11 in the system 14 may be achieved by providing the prescriber 11, for example, by mail, facsimile transmission, or on-line transmission, with a registration card or on/off-line form, preferably together with appropriate educational materials concerning, for example, the particular drug for which the prescriber 11 is being registered to prescribe, as well as suitable methods for delivering the drug to the patient, including the drug delivery methods described herein. The prescriber 11 will preferably complete the registration card or form by providing information requested therein, and the registration card or form will preferably be transmitted to the system 14, for example, by mail, facsimile transmission or on-line transmission. Information which may be requested of the prescriber 11 in the registration card or form may include, for example, the prescriber's name, address, and affiliation, if any, with one or more health care institutions. The prescriber's information in the registration card or form is then entered into the data storage section 33 by the prescriber/pharmacy information registering unit 35. The prescriber information registering unit may examine the qualification of the prescriber 11 based on the predetermined qualification criteria discussed above. It is contemplated that the registration of the prescriber 11 into the system 14 may also be achieved, for example, by telephone, and/or through the use of an integrated voice response system 14.

In the system 14, pharmacies who are qualified to fill prescriptions for the particular drug being prescribed including, for example, teratogenic drugs, are also registered. Once registered in the system 14, the system 14 recognizes that the pharmacies may be eligible to dispense the involved drug to patients who are in need of the drug. Generally speaking, in order to become registered in the system 14, the pharmacy 12 may be required to comply with various aspects of the methods described herein including, for example, registering the patient (also in the system 14), ensuring that the patient complies with certain aspects of the drug delivery methods, as well as other aspects of the present methods, as described in detail below. As with the registration of the prescriber 11 in the system 14, the registration of the pharmacy 12 may be achieved by providing the pharmacy 12, for example, by mail, facsimile transmission, or on-line transmission, with a registration card or form, preferably together with appropriate educational materials concerning, for example, the particular drug for which the pharmacy 12 is being registered to dispense, as well as suitable methods for delivering the drug to the patient, including the drug delivery methods described herein. The pharmacy 12 may then have the registration card or form completed by providing the information requested therein, which thereafter may be returned to the manufacturer or distributor of the drug, or other authorized recipient of the registration card or form, for example, by mail, facsimile transmission or on-line transmission and register in the system 14. Information which may be requested of the pharmacy 12 in the registration card or form may include, for example, the pharmacy's name, address, and affiliation, if any, with any health care institution such as, for example, a hospital, health care organization, and the like. The pharmacy's information in the registration card or form is then preferably entered into the data storage section 33 by the pharmacy information registration unit 36. The pharmacy information registering unit may examine the qualification of the pharmacy 12 based on the predetermined qualification criteria discussed above. It is contemplated that the registration of the pharmacy 12 into the system 14 may also be achieved, for example, by telephone and/or through the use of an integrated voice response system 14.

As noted above, the system 14 described herein also involves the registration of the information of the patient (patient parameters). Generally speaking, in order to become registered in the system 14, the patient may be required to comply with various aspects of the methods described herein. The registration of the patient may be carried out by the registered pharmacy 12, for example at the time of the patient's initial visit to the pharmacy 12. It has been found, however, that it may be more efficient, and better compliance with the methods of the present invention may be provided, if registration of the patient is carried out by the registered prescriber 11 of the drug at the time the initial prescription is generated.

In preferred form, the prescriber 11 will typically have a registration card or form filled out for the patient, which includes information on the patient, such as the patient's name, sex, mailing address, date of birth, and the like. Information on the prescribing prescriber 11 and dispensing pharmacy 12, such as the information described above for the registration thereof, may also be desirably entered on the patient registration card or form. The completed card or form may then be forwarded to the manufacturer or distributor of the drug, or other authorized recipient of the registration form, for example, by mail, facsimile transmission or on-line transmission. Where registration is by mail or facsimile, entry of the registration into the system 14 may preferably include the use of optical character recognition (OCR) software. It is also possible that the registration of the patient into the system 14 may also be achieved, for example, by telephone and/or through the use of an integrated voice response system. The information of the patient is to be stored in the data storage section 33 by the patient parameter/risk information registering unit 37. The patient parameter/risk information registering unit 37 may examine the patient's qualification based on the information of the patient received and the information of the drug to be administrated. The patient parameter/risk information then will be registered in the data storage section 33 as shown in reference numeral 47.

Preferably, information will also be collected from the patient that may be probative of the risk that a known or suspected side effect will occur if the drug is taken by the patient. This information may then be compared with a predefined set of risk parameters for the drug, which in turn define a plurality of risk groups, so that analysis of the information will permit assignment of the patient to at least one of the risk groups. This risk group assignment is then also entered and transmitted to the system 14. This assignment may be performed by the prescriber 11, who may then include the risk group assignment on the patient's registration card or form, or may be performed by another individual, such as a nurse, technician, or office personnel, who preferably interprets the information and assigns the patient to one of the risk groups, accordingly. The assignment of the risk group to the patient is stored into the data storage unit 33 by the patient parameter/risk group registering unit 37.

As discussed above, it is preferable that a plurality of risk groups, each based upon a predefined set of risk parameters, be established for the drug which is to be administered. As will be evident to those of skill in the art, the risk parameters to be considered and the risk groups defined by those parameters, will be based upon factors which influence the risk that a known or suspected adverse side effect will occur if the patient receives the drug, and will vary depending upon the drug in question. Where the drug is a teratogenic drug, for example, such risk parameters may include elements which would impact the risk of a foetus being exposed to the drug, such as the age, sex and reproductive status of the patient. For example, a first risk group may comprise female patients of child bearing potential; a second risk group may comprise female patients of non-child bearing potential; a third risk group may comprise sexually active male patients; a risk group may comprise sexually inactive male patients. Additionally, there may be a risk group established for patients to whom administration of the drug may be strictly contraindicated, and patients assigned to such a group will not be approved to receive the drug. For other drugs, different factors, such as those influencing the likelihood that certain preexisting conditions may exist, or the likelihood of certain other drugs being used concomitantly with the prescribed drug, may define the relevant risk parameters.

The definition of a plurality of the risk groups and risk parameters that are established for the drug to be administered are stored also in the data storage unit at the system 14 as shown with reference numeral 45. In this embodiment, the patient assessment review unit 38 assures, based on the assignment of the risk group, risk parameters, patient information and prescriber information, that assignment of the risk group was conducted correctly by following the predetermined steps of assigning a patient to the risk group for the drug to be administrated. When the assignment of the risk group did not follow the predetermined steps, then the system 14 will generate an alert.

In this embodiment, as discussed above, the patient assessment unit 38 compares the information on the patient with a predefined set of risk parameters for the drug, and generates a plurality of risk groups, so that the review unit 38 can analyze whether the risk group assigned to the patient by the prescriber 11 is appropriate or not.

As described, by assigning each patient to a risk group, the steps that will be taken to minimize the chance that the drug is dispensed to a contraindicated patient, and to minimize the risk that a known or suspected adverse side effect will occur, can be tailored to suit the circumstances of that particular patient. For example, depending upon which risk group a patient is assigned to, the system 14 may requires that additional information may be collected from the patient. As discussed more fully below, such additional information may be in the form, for example, of a patient survey. Such additional information may also include the results of certain diagnostic tests which have been performed. Based upon the additional information, the patient's risk group assignment may then remain the same, or the patient may be assigned to a different risk group, which may in turn require that further additional information be collected from the patient.

Therefore, in the system 14, a patient assessment review unit 38 makes sure, based on the assignment of the risk group, risk parameters, patient information and prescriber information, whether or not the additional information should be collected from the patient. When the decision is made to request additional information, the system 14 will generate an alert for requesting the additional information.

The rule for making the above decision can be stored in the data store unit 32 as a risk parameter/risk group definition information 45 and the review unit 38 utilizes the rule to process the request from the prescriber 11. The definition 45 may not be limited the one discussed above and other examples will be discussed below.

For example, in the system 14, the monitoring of two, three or more drugs either administered to or proposed for administration to a patient may also be accomplished in order to avoid or diminish the likelihood of the occurrence of one or more side effects. Thus, combinations of drugs which, when administered to an individual patient, may give rise to an increased likelihood of side effects, may be registered in the system 14, and the patient's risk group assignment may be reflective of this increased risk. In the system 14, a physician is registered to prescribe at least one of the drugs for a patient and a pharmacy 12 is registered to fill such prescription. In this way, through assignment of such patient to one or more risk groups, the patient assessment review unit 38 can generate an alert for avoidance of harmful drug interactions may be attained. The definition to review the assignment of the risk group is registered at the data storage unit 33 according to each of the drug to be administrated.

It is preferred that for any given risk group, the system 14 may define a predetermined additional set of information which is to be collected from the patient. This additional set of information may be obtained prior to the initial dispensation of the drug to the patient and/or may be obtained from the patient on a periodic basis. This information may include information not previously obtained from the patient, or may simply reiterate previously asked questions, and repeat diagnostic tests which were conducted previously. The information may relate to the patient's conduct, or may relate to the patient's past or ongoing medical treatment, such as other procedures or medication which the patient may have received or is still receiving. For example, the additional set of information may be in the form of a survey or questionnaire regarding the patient's behavior and compliance with risk avoidance measures and may thus be probative of whether the risk of occurrence of an adverse side effect has increased, decreased or remained the same. Based upon the responses by the patient, the patient's risk group assignment may, if appropriate, be changed accordingly. Alternatively, where side effects which are known or suspected of being caused by a combination of drugs, the questions asked of the patient may be probative of the likelihood that the patient may take such a combination of drugs. Similarly, where sharing of drugs by the patient may be a matter of concern, the survey may be probative of the risk that the patient may be sharing the hazardous drug with another, and hence increase the risk that a contraindicated individual may receive the drug. Such additional information and information on change of the risk group may be collected and determined by the prescriber 11 (medical institution) and transmitted to the system 14 and registered into the data storage unit.

The additional information may also include the results of certain diagnostic tests which have been performed on the patient. Such diagnostic tests may be probative, for example, of the risk of exposure of a foetus to a teratogenic drug, may test for the presence of a risk factor for the adverse side effect of concern, or may be probative of the onset of that side effect. Where the use of combinations of more than one drug are known or suspected of causing an increased risk of the occurrence of a side effect, the diagnostic testing may include testing for the presence of one or more of those drugs, or evidence of the use by the patient of such other drugs. Additionally, diagnostic tests may be probative of the concentration of one or more drugs, including the prescribed drug or drugs, to assure that appropriate dosing is maintained. In certain embodiments of the invention, the additional information may comprise data with respect to levels of white blood cells in a patient. These data may be probative of the existence of neutropenia in a patient. In certain other embodiments of the invention, the additional information may comprise data with respect to levels of platelets in a patient. These data may be probative of thrombocytopenia in a patient. In certain embodiments of the invention, the diagnostic testing may comprise data probative of the risk of DVT or the risk of PE.

Such diagnostic testing may be conducted on any bodily fluid or waste product of the patient, including the blood, serum, plasma, saliva, semen or urine, as well as the feces. Diagnostic testing may also be performed on a biopsy of any tissue of the patient or may include genetic testing, which may be indicative of a genetic predisposition to a particular adverse side effect. Other forms of diagnostic testing, such as diagnostic imaging, or tests which may be probative of the proper functioning of any tissue, organ or system 14 are also contemplated. Preferably, the additional information and/or diagnostic test results are obtained and entered in the system 14 before the patient is approved to receive the drug. The definition to decide whether or not the approval code is stored in the data storage unit 33 and the approval code generation unit will examine the consented patient risk information 48 registered in the data storage unit.

Additionally, where the information indicates that the risk of the adverse side effect occurring outweighs the potential benefit of the drug, the patient may be assigned to a risk group that will preclude approval of dispensation of the drug to that patient.

In accordance with the system 14 of the preset embodiment, therefore, the delivery of the drug to the patient may involve the following steps. As a prelude to prescribing and dispensing the drug to the patient, the prescriber 11 and the pharmacy 12 are registered in the system 14, as described above. If the prescriber 11 is not registered in the system 14, the prescriber 11 will be ineligible to prescribe the drug. Similarly, if the pharmacy 12 is not registered in the system 14, the pharmacy 12 will be ineligible to dispense the drug.

In the course of an examination of a patient, including patients suffering from one or more diseases and/or disorders such as, for example, erythema nodosum leprosum (ENL) or multiple myeloma, the prescriber 11 may determine that the patient's condition would be improved by the administration of a drug such as, for example, a teratogenic drug or a suspected teratogenic drug, including thalidomide and lenalidomide. Prior to prescribing the drug, the prescriber 11 preferably counsels the patient, for example, on the various risks and benefits associated with the drug. For example, the prescriber 11 preferably discusses the benefits associated with taking the drug, while also advising the patient on the various side effects associated therewith. In embodiments of the invention wherein the prescriber 11 assigns the patient to a specific risk group, the disclosure is preferably tailored to that risk group assignment. Thus, a patient who may acquire or impart a condition or disease for which the drug is contraindicated is preferably counseled by the prescriber 11 on the dangers associated therewith and advised as to risk avoidance measures which may be instituted. Preferably the patient is provided full disclosure of all the known and suspected risks associated with taking the drug. For example, in the case of teratogenic drugs or drugs suspected of being teratogenic, the prescriber 11 preferably counsels the patient on the dangers of exposing a foetus, either one which may be carried by the patient or one carried by a recipient of the bodily fluids of the patient, to the teratogenic drug or drugs suspected of being teratogenic. Such counsel may be provided verbally, as well as in written form. In preferred embodiments, the prescriber 11 provides the patient with literature materials on the drug for which a prescription is contemplated, such as product information, educational brochures, continuing education monographs, and the like. Thus, in the case of methods involving teratogenic drugs or drugs suspected of being teratogenic, the prescriber 11 preferably provides patients with literature information, for example, in the form of the aforesaid product information, educational brochures, continuing education monographs, and the like, warning the patient of the effects of the drug (known or suspected) on foetuses. In the case of other drugs which are known or suspected of causing an adverse side effect, the patient is counseled as to the dangers of taking the drugs, and of steps which may be taken to avoid those risks. For example, if the concomitant use of the drug and another drug, for example alcohol, is to be avoided, the prescriber 11 advises the patient of the risks of drinking alcohol while taking the drug.

With particular reference to counseling provided in connection with teratogenic drugs and drugs suspected of being teratogenic, the prescriber 11 preferably counsels female patients that such drugs must never be used by pregnant women. If the patient is a female of child-bearing potential (i.e., a woman who is capable of becoming pregnant), the prescriber 11 preferably counsels the patient that even a single dosage of certain teratogenic drugs or drugs suspected of being teratogenic, such as thalidomide and lenalidomide, may cause birth defects. Accordingly, the patient is preferably counseled to avoid sexual intercourse entirely, or if sexually active, to use appropriate forms of contraception or birth control. For both male and female patients, the prescriber 11 preferably provides counsel on the importance of using at least two forms of effective birth control methods, with one form preferably being a highly effective hormonal method, and the other form preferably being an effective barrier method. The patients are preferably counseled to use the birth control methods for a period of time prior to and during treatment with the teratogenic drug or drug suspected of being teratogenic, as well as for a period of time after treatment with the drug has been terminated. In preferred embodiments, the patient is counseled to use at least two forms of birth control for at least about 4 weeks prior to initiation of treatment, during treatment, and for at least about 4 weeks after treatment has been terminated. It may be desirable for the prescriber 11 to personally provide female patients who are capable of becoming pregnant with one or more contraceptive devices or formulations.

Male patients who are being prescribed a teratogenic drug or drug suspected of being teratogenic are preferably counseled to use condoms every time they engage in sexual relations, since many teratogenic drugs or drugs suspected of being teratogenic may be found in semen. Male patients are also preferably counseled to contact their prescriber 11 if they have sexual intercourse without a condom, and/or if it is believed that they may have caused a pregnancy. As with female patients, it may be desirable for the prescriber 11 to provide male patients who are capable of impregnating female patients with a contraceptive device or formulation. Other advice relative to birth control that the prescriber 11 may provide to the patient would be apparent to one skilled in the art, once armed with the teachings of the present application. If the prescriber 11 who is prescribing the teratogenic drug or drug suspected of being teratogenic is unaware of certain aspects of the available forms of birth control and the advantages and disadvantages associated therewith, the patient should be referred to a prescriber 11 who is knowledgeable on such matters, prior to be being prescribed the involved drug. Generally speaking, as discussed below, counseling on teratogenecity, birth control, and the like is preferably given only to female patients who are capable of becoming pregnant, or to male patients who are capable of having sexual relations with partners who are or can become pregnant. In this manner, unnecessary counseling, for example, to women who are no longer of child-bearing age or men who are incapable of sexual relations with such women, may be avoided.

With further reference to methods involving teratogenic, suspected teratogenic, or other potentially hazardous drugs, it is also preferred that the prescriber 11 advise the patient to not share the drug with anyone else, and particularly that the drug should be kept out of the reach of children as well as women of child-bearing potential. In the case of female patients, particularly female patients of child-bearing potential, the prescriber 11 should give the patient a pregnancy test, preferably a serum pregnancy test, prior to and during treatment with the teratogenic drugs and drugs suspected of being teratogenic. To begin receiving the teratogenic drug or drug suspected of being teratogenic and to continue taking the drug, female patients of child-bearing potential should continue to have negative pregnancy tests. In certain embodiments of the invention, a patient may be tested for pregnancy (a) before drug administration; (b) once per week during the first 28 days of drug administration; and/or (c) following the conclusion of a course of treatment comprising drug administration. In other embodiments of the invention, a patient may be tested for pregnancy 10, 11, 12, or 14 days before a prescription is written and again within 24 hours before a prescription is written.

With further reference to certain embodiments of the invention involving drugs capable of causing neutropenia or thrombocytopenia, such as lenalidomide, a prescriber 11 may monitor blood counts of a patient. For example, blood counts can be monitored every 2 weeks for the first 12 weeks of administration of a drug and then at least monthly thereafter. By way of additional example, blood counts can be monitored every 2 weeks for the first 8 weeks of administration of a drug and then at least monthly thereafter. In certain embodiments of the invention, to begin receiving a drug capable of causing neutropenia or thrombocytopenia and/or to continue taking the drug, patients should have acceptable blood counts. In certain other embodiments of the invention, to begin receiving a drug capable of causing neutropenia or thrombocytopenia and/or to continue taking the drug, patients should receive blood transfusions or one or more medications capable of ameliorating unfavorable or low blood counts.

The patient is also preferably counseled by the prescriber 11 to discard or return to the prescriber 11, pharmacy 12, manufacturer or distributor any unused portion of the prescribed drug.

As would be apparent to one of ordinary skill in the art, once armed with the teachings of the present application, one or more aspects of the counseling described above may be applicable, in certain circumstances, for drugs other than teratogenic drugs.

In addition to receiving counseling on the drug being prescribed, including counseling, for example, on birth control, and prior to receiving a prescription for the drug, the methods of the present invention preferably involve requiring the patient to fill out an informed consent form which is signed by the prescriber 11, as well as the patient. The prescriber 11 should retain a copy of the informed consent form for his/her records. Verification that the patient has given his/her informed consent is also be registered in the system 14 as consented patient risk information 47. Preferably, this verification is provided by the prescriber 11, and may be included, for example, with the patient registration information and risk group assignment. It has surprisingly been found that by having the prescriber 11, rather than the pharmacy 12, verify the patient's informed consent, the methods of the present invention may operate more efficiently, leading to better compliance, and hence decreased risk that the adverse side effect will occur, may be achieved.

By filling out and signing an informed consent form, the patient acknowledges that he/she understands the risks associated with taking the drug. In the informed consent form, the patient preferably agrees to comply with the risk avoidance measures provided, and to behave in a manner which is consistent with the prescriber 11's counsel. For example, in cases involving, for example, teratogenic drugs or drugs suspected of being teratogenic, the patient may agree to use at least one form of birth control, with female patients agreeing to use at least two forms of birth control. In preferred embodiments, where the patient's risk group assignment so dictates, the patient will agree to undergo periodic diagnostic testing relevant to the risk that the adverse side effect to be avoided may occur or be occurring. In preferred embodiments involving teratogenic drugs or drugs suspected of being teratogenic, female patients preferably agree also to undergo pregnancy testing, preferably serum pregnancy testing, before, during and after treatment with the teratogenic drug or drug suspected of being teratogenic. In certain embodiments of the invention, a patient may be tested for pregnancy (a) before drug administration; (b) once per week during the first 28 days of drug administration; and/or (c) following the conclusion of a course of treatment comprising drug administration. In other embodiments of the invention, a patient may be tested for pregnancy 10, 11, 12, or 14 days before a prescription is written and again within 24 hours before a prescription is written. Female patients preferably will also acknowledge that, at the time they are being prescribed the drug, especially teratogenic drugs and drugs suspected of being teratogenic, they are not pregnant, they will immediately stop taking the drug if they become pregnant, and they will not try to become pregnant for at least 4 weeks after treatment with the drug is terminated. Female patients, especially female patients for whom a teratogenic drug or drug suspected of being teratogenic will be administered, preferably further agree to contact their prescriber 11 if they wish to change one or more of the birth control methods being used and to have an additional pregnancy test if a menstrual period is missed. Female patients, especially female patients to be treated with teratogenic drugs and drugs suspected of being teratogenic, will preferably agree also to not breast-feed while being treated with the drug.

Male patients who are being prescribed the drugs according to the methods described herein, especially teratogenic drugs and drugs suspected of being teratogenic, will preferably agree to avoid having unprotected sexual relations with a woman, particularly a woman of child-bearing potential during treatment with the drug. In doing so, male patients will preferably further agree to use a condom during sexual relations with a woman, with latex condoms being preferred. Both male and female patients will also preferably agree to not share the drug with anyone, and to acknowledge that they cannot donate blood while taking the drug, with male patients agreeing also to not donate sperm while taking the drug. In addition, the patients will preferably agree to take part in a confidential patient survey, for example, before, during and after treatment with the drug. The patient survey provides information, for example, to the prescriber 11, manufacturer and/or distributor of the drug, as well as any group or body which may be established to generally provide oversight on the distribution of the drug, on information regarding the general lifestyle of the patient, including detailed information on the patient's sexual behavior. In this manner, the survey may assist in identifying patients who engage in risky behavior, as well as patients who are non-compliant with the methods described herein. Such risky behavior and/or non-compliance may lead to a suspension or intervention of the patient's treatment with the drug, with re-education being provided to the patient.

The information obtained from the survey is preferably also entered into the system 14. Once entered into the system 14, the patient assessment review unit 38, consent review unit and/or approval code generation unit 40 glean therefrom information regarding the level of risk associated with the administration of the involved drug to the various patients. The system 14 will identify to review, from among the entire population of registered patients, one or more subpopulations of patients for which the involved drug may be more likely to be contraindicated. For example, it may be possible to identify a subpopulation of female patients who are capable of becoming pregnant and/or a subpopulation of male patients who are capable of impregnating female patients. Preferably, the counseling information discussed above relating to exposure of a foetus to a teratogenic drug or drug suspected of being teratogenic may then be addressed primarily to this subpopulation of patients.

If the risk is considered to be acceptable, the patient may continue to receive the drug, using the methods described herein. If the risk is considered to be unacceptable, additional counseling may be provided to the patient or, if necessary, treatment of the patient with the involved drug may be terminated, with alternate treatment modalities being provided. In preferred embodiments, female patients will agree to complete a patient survey at least once every month, with male patients agreeing to complete a patient survey at least once every three to six months. The survey may be conducted by mail, facsimile transmission, on-line transmission or by telephone. Preferably, the survey is conducted by telephone through the use of an integrated voice response system (IVR).

After the patient has received counseling as described above, and has also filled out and signed an informed consent form, and it is determined that the drug which is to be prescribed is not contraindicated for the patient (such as, for example, a negative pregnancy test in the case of female patients for whom a prescription is desired for a teratogenic drug or drug suspected of being teratogenic), the prescriber 11 may prescribe the drug to the patient. In preferred embodiments of the present invention, the amount of the drug which is prescribed to the patient is for a limited amount, preferably no more than about 28 days. Refills for the drug will not be permitted without a renewal prescription from the prescriber 11, as discussed in detail below. In order to have the prescription filled, the patient preferably presents the prescription and the informed consent form to a pharmacy 12 who has been registered, as discussed above. It is contemplated that the patient may bring the prescription to an unregistered pharmacy 12. If so, the pharmacy 12 may take steps to become registered in the system 14, for example, by immediately contacting the manufacturer of the drug. Once registration of the pharmacy 12 is completed, the distribution procedure described herein may resume, per the discussion hereinafter. Of course, this may introduce a delay into the prescription process, and the patient may desire to take the prescription for the drug to an alternate, registered pharmacy 12. If the patient does not present a completed informed consent form to the pharmacy 12, or if verification of such informed consent has not previously been registered in the system 14, the review unit 38, 39, approval code generation unit 40 and/or permission generation unit 41 are not allowed to issue an approval code or a permission code so that prescription may not be filled. In this case, pharmacy 12 may contact the prescribing prescriber 11 to have an informed consent form filled out for the patient and register it to the system 14.

The drug is preferably supplied to the pharmacy 12 (as well as the patient) in packaging, such as individual blister packs, which includes warnings regarding the risks associated with the drug, as well as the importance of various aspects of the present methods such as, for example, pregnancy testing and the use of contraception (in the case of teratogenic drugs and drugs suspected of being teratogenic), and the dangers associated with sharing the drug with others, among other aspects.

As noted above, the drug is preferably prescribed and dispensed to the patient in a limited amount, with a prescription amount of no more than about 28 days being preferred, and preferably with no refills being permitted. Thus, for the patient to obtain an additional prescription, it is generally necessary for the patient to have a follow-up visit with the prescriber 11. Such a follow-up visit preferably takes place at least each time the patient requires a renewal of the prescription, and possibly more often if the patient requires, for example, additional counseling. At the follow-up visit, the patient will preferably receive additional counseling regarding the risks and benefits associated with taking the drug, as well as further counseling on birth control (if applicable). The patient will also preferably complete an additional patient survey to provide current information regarding their lifestyle, including their sexual behavior and, if female of childbearing potential, be administered a new pregnancy test. In certain embodiments of the invention, a patient may be tested for pregnancy (a) before drug administration; (b) once per week during the first 28 days of drug administration; and/or (c) following the conclusion of a course of treatment comprising drug administration. In other embodiments of the invention, a patient may be tested for pregnancy 10, 11, 12, or 14 days before a prescription is written and again within 24 hours before a prescription is written.

After receiving the counseling and completing the patient survey, and if the pregnancy tests for female patients are negative, the prescriber 11 may fill out a new prescription for the drug. As with the original prescription, the renewal prescription is preferably for a limited period of time, with no more than about 28 days being more preferred. Above discussed rules are also registered as risk parameters/definition information 45.

In certain embodiments, the prescriber 11 may also receive reminders, for example, via mail, facsimile, or on-line transmission, from the system 14 at the manufacturer, distributor or other group or body providing oversight on drug distribution, that the prescriber 11 has prescribed a hazardous drug to patients which may be contraindicated, and that the involved patients may require additional counseling and diagnostic testing. Such reminders may preferably be delivered to the prescriber 11, for example, from about 14 to about 21 days after the previous prescription was filled.

As with the original prescription from the prescriber 11, the patient should present all renewal prescriptions to a registered pharmacy 12. Prior to filling out the prescription and dispensing the drug, the pharmacy 12 preferably confirms, for example, via a standard on-line transmission or via telephone via IVR that the patient has been registered and is eligible to receive the drug. When patient eligibility has been confirmed, the pharmacy 12 may dispense the drug to the patient. If the patient is ineligible, the pharmacy 12 generally may not dispense the drug to the patient. The pharmacy 12 may then contact, for example, the prescribing prescriber 11 or the manufacturer of the drug to initiate patient registration. In preferred form, the pharmacy 12 will be precluded from dispensing the drug if the patient has more than about 7 days of drug supply from the previous prescription, and/or if the new prescription was written more than about 14 days before the date the patient visits the pharmacy 12 to have it filled.

The registration of the prescriber 11, pharmacy 12 and patient into the system, according to the methods described herein, provide the system to monitor and authorize distribution of contraindicated drugs, including teratogenic drugs and drugs suspected of being teratogenic. Thus, the system 14 may serve to deny access to, dispensing of, or prescriptions for contraindicated drugs, including teratogenic drugs and drugs suspected of being teratogenic, to patients, pharmacies or prescribers who fail to abide by the methods of the present invention. As noted above, prescribers who are not registered in the system 14 generally may not prescribe the drug, and pharmacies who are not registered generally may not dispense the drug. Similarly, the drugs generally may not be prescribed and/or dispensed to patients who are not registered in the system 14. In addition, patients may be required to present an informed consent form to the pharmacy 12. Unless such a form is presented to the pharmacy 12, or verification of such informed consent has been provided by the prescriber 11 and registered in the system 14, the patient generally may not receive the prescription for the drug. As noted above, only limited amounts of the drug may be prescribed to the patient, with no refill prescriptions being permitted.

In the present embodiment, the system 14 may require that the registered pharmacy 12 consult this system 14 to retrieve a prescription approval code before dispensing the drug to the patient. As used in this application, a “prescription approval code” is a code that refers not merely to a number that is associated with a prescription, but instead is a code that represents the fact that a determination has been made that the risk of the side effect occurring is acceptable, and that the approval—an affirmative decision—has been made for the prescription to be filled. This approval code is preferably not provided unless the prescriber 11, the pharmacy 12, the patient, the patient's risk group and the patient's informed consent have been properly registered in the system (shown with reference numeral 48). Additionally, depending upon the risk group assignment, generation of the prescription approval code may further require the registration in the system of the additional set of information, including periodic surveys and the results of diagnostic tests, as have been defined as being relevant to the risk group assignment. Thus, to comply with the system 14 and receive approval to dispense the drug as prescribed, the registered pharmacy 12 need retrieve the approval code. If the prescription approval code is not forthcoming, the patient may be directed to complete the necessary survey, for example, by telephone, or may be directed back to the prescriber 11 for completion of necessary diagnostic tests. In this embodiment, the permission code generation unit 41 will issue a permission code to the pharmacy 12 if all the requirements are fulfilled to dispense the drug as prescribed.

In this manner, the effort required by the pharmacy 12 is minimized, and greater compliance with the present methods may efficiently and advantageously be achieved. Additionally, the embodiments described herein may provide greater assurance that all required further information, as is appropriate to the patient's risk group assignment, has been obtained before the drug is dispensed to the patient, and thereby minimize the risk that an adverse side effect will occur.

While the delivery of teratogenic drugs and drugs suspected of being teratogenic are an aspect of the present invention which has clearly apparent benefit, other types of drugs may also beneficially be prescribed and delivered in accordance with one or more embodiments hereof and all are contemplated hereby. For example, the methods of the present invention may be used for delivery of a drug which is known or suspected of causing liver damage in many patients who take the drug. One such drug is isoniazid, a widely known treatment for tuberculosis (TB). In following a method of the present invention, a registered physician may wish to prescribe isoniazid to a patient who has tested positive for TB. The physician may register the patient in the system 14, along with certain information regarding the patient's age, medical condition, and so on. If the patient is a young adult, for example, and presents with no other complicating risk factors, the patient may be assigned to a risk group that is designated to receive counseling regarding certain behavior, such as the concomitant use of alcohol, which is to be avoided. The patient may be fully informed of the risks of liver damage that may result from taking isoniazid, and is preferably counseled to avoid drinking any alcoholic beverages while undergoing treatment with the drug. Preferably, the patient signs an informed consent form, and the prescribing physician transmits verification of the informed consent, along with the patient's registration form and risk group assignment to the system 14. The physician then provides the patient with a prescription for the isoniazid. Upon presentation of the prescription to a registered pharmacy 12, the system 14 is consulted to verify that the patient and prescriber 11 are registered therein, and that the patient's risk group assignment and informed consent have been provided.

If the patient's risk group assignment so indicates, certain diagnostic tests may additionally be required, so that baseline data may be obtained, before the prescription will be approved for filling. The patient's risk group may indicate, for example, that serum liver enzymes should be evaluated on a monthly basis. Under these circumstances, the prescription will preferably be filled for no more than about 30 days.

The patient will also preferably be advised that completion of a monthly survey will be required. This survey may include a questionnaire which is probative of the patient's alcohol consumption over the past month. The survey may also include questions which are probative of certain symptoms which may be indicative of the early onset of liver damage or other side effects known or suspected of being caused by isoniazid. Additionally, questions regarding the patient's concomitant use of other drugs which are known to be hazardous when taken in combination with isoniazid, may be asked. Preferably, this survey is conducted telephonically, using an integrated voice response system, and the responses are entered in the storage medium. Based upon the patient's responses, the patient's risk group assignment is adjusted or left the same, as may be appropriate.

The patient is preferably further instructed that periodic diagnostic testing may also be necessary for continued approval of a prescription. Preferably, the diagnostic testing will include an assay of the patient's serum liver enzyme levels, to screen for early signs of liver damage. Additionally, the diagnostic testing may include screens for the presence of other drugs known to also cause liver damage, or to be hazardous if taken in combination with isoniazid. A prescription approval code generally will not be generated for subsequent prescriptions or refills until such periodic tests have been performed and satisfactory results entered into the system 14. If a prescription approval code is not received by the pharmacy 12, the patient is directed to complete the requisite survey or tests, or to return to the doctor for further consultation.

If the test results or survey indicate that the risk of liver damage has increased, the patient's risk group assignment may be changed, or the patient will be directed to consult with the prescriber 11 before any further isoniazid may be dispensed. In this way, the development of the adverse side effect of concern may be monitored. For example, if the tests indicate that some liver enzymes are marginally elevated, the patient's risk group status may be changed from a first risk group to a second risk group. As a member of this second risk group, the patient may be required to undergo additional diagnostic testing before approval will be given to receive the drug. Such testing may include, for example, liver function tests, to further diagnose the level of cellular damage potentially being caused by the isoniazid, or the combination of isoniazid and other drugs, such as alcohol. In more extreme cases, a diagnostic ultrasound of the liver, or even a liver biopsy may even be indicated. Ultimately, if the risk of continued administration becomes so great that it outweighs the possible benefits of continued treatment with isoniazid, the patient may be assigned to a risk group which indicates that the drug may no longer be dispensed to that patient.

The methods of the present invention may similarly be employed, for example, where the patient is undergoing treatment for infection with the Human Immunodeficiency Virus (HIV). Patients who test positive for HIV may be treated with one or more drugs to combat the onset of the Acquired Immune Deficiency Syndrome (AIDS). Frequently, HIV positive patients are administered an “AIDS cocktail” of several drugs including, for example, a combination of one or more inhibitors of viral protease and reverse transcriptase. By following the methods of the present invention, the patient may continue to receive the combination of drugs, while the risk of adverse side effects from administration of the drugs may be minimized. Additionally, the methods of the present invention may be desirably and advantageously used to educate and reinforce the actions and behaviors of patients who are taking a drug, as well as prescribers who prescribe the drug and pharmacies which dispense the drug.

As with methods of the invention previously described, when a patient has tested positive for HIV, a registered prescriber 11 may obtain background information on the patient and see that a registration form is completed so that the patient may be registered in the system 14. The prescriber 11 may prescribe one or more drugs to the patient, including drugs which may be known or suspected of causing adverse side effects, either alone or in combination with each other or with other drugs. Depending upon the drugs prescribed, and also upon information which the prescriber 11 will preferably obtain regarding the patient's medical history, physical condition and lifestyle, the patient will preferably be assigned to at least one risk group. Based upon this risk group assignment, the patient will preferably receive educational materials and counseling regarding the risks associated with the prescribed drugs, and be advised of the importance of the treatment regimen. The patient will also preferably receive counseling regarding the risk of spreading the disease to others, including a foetus which may be carried by the patient and any recipient of a bodily fluid of the patient. Thus, the patient may be counseled regarding the preferential use of one or more methods of birth control, and may also be provided with a contraceptive device by the prescriber 11. Additionally, the patient will preferably be counseled not to share any of the drugs with others, and to avoid taking any medications not prescribed. In this way, the patient will preferably be counseled both as to methods for minimizing the spread of the disease, as well as to methods for avoiding the occurrence of one or more side effects which may result from the taking of the medication. Preferably, upon full disclosure of all risks inherent in the treatment regimen, the prescriber 11 will obtain and register in the system 14 the informed consent of the patient to receive the medication and to comply with the methods described herein for avoiding the occurrence of one or more side effects which may result from taking the drug or drugs prescribed.

To facilitate compliance with the methods of the present invention, and to minimize the likelihood of the occurrence of a known or suspected adverse side effect from treatment with the prescribed drug or drugs, it is preferable that when prescriptions for the drug are presented to a registered pharmacy 12, the system 14 is consulted to retrieve a prescription approval code before the drug is dispensed to the patient. In order for a prescription approval code to be generated, and based upon the patient's risk group assignment, the patient may be required to provide additional information, which may then be entered in the storage medium before approval of the prescription may be provided. For example, the patient may be required to undergo certain diagnostic tests. In a patient with HIV, for example, testing for viral load may be required, both initially and on a periodic basis, so that dosing of the medication may be adjusted, as necessary. The patient may also be required to complete a survey which asks questions probative of the likelihood that the patient is taking other medications, or beginning to exhibit symptoms which may be of importance to the selection and implementation of a therapeutic regimen. Such additional information may be required both before the initiation of treatment and on a periodic basis during treatment, as new prescriptions and prescription refills are generated. Based upon the information provided by the patient, and the results of any diagnostic tests which have been performed, the patient's risk group assignment may stay the same, or may be changed, as indicated. The patient's risk group assignment may also be changed based upon the length of time the patient has been receiving a given drug or medication.

A periodic patient survey may serve both to remind the patient of the requirements of the drug distribution program, and to obtain information which may be probative of the risk that an adverse side effect may occur. For example, the survey may include questions probative of the patient's behavior as it relates to the sharing of medication with other HIV positive individuals, and the patient's compliance with measures for avoiding the spread of the disease. Additionally, the survey may include questions regarding other drugs, medications or treatments which the patient might be availing themselves of, which would impact the risk of an adverse side effect occurring.

The survey may also contain questions which are probative of the onset of certain symptoms which may be indicative of the need for changes in the patient's treatment regimen. For example, some questions may be probative of the onset of depression in the patient, a common occurrence amongst AIDS sufferers. Answers to questions in the survey that are indicative of depression, for example, may cause the patient's risk group assignment to change such that the patient is directed to return to the prescriber 11 for determination of whether treatment with an anti-depressant drug is indicated. Similarly, certain drugs, such as protease inhibitors, for example, may lead to abnormal redistribution of fat in certain patients. This symptom may be seen in conjunction with certain metabolic defects and may in turn be symptomatic of conditions such as high blood sugar and high cholesterol. Questions relating to this abnormality may be included on the survey, and answers which indicate that the patient has noticed such physical changes may lead to the assignment of the patient to a risk group in which diagnostic tests probative of the metabolic abnormalities are required before further access to the drug in question is permitted.

As with the survey, the diagnostic testing which the patient may be required to undergo may vary with, and preferably is appropriate to, the patient's risk group assignment. In addition to testing for the patient's viral load, periodic diagnostic testing may be appropriate, for example, to evaluate the level of one or more medications in the patient. Dosage of reverse transcriptase inhibitors, for example, may be critical to the risk of occurrence of an adverse side effect. At the same time, various drugs which are often used in combination may share similar metabolic pathways, so that the addition of a second drug to the treatment regimen may greatly affect the pharmacokinetics of the first drug, thereby necessitating an adjustment in the dose of the first drug. In the case of treatment with an “AIDS cocktail” containing, for example, the use of ritonavir, a well-known protease inhibitor, may greatly impact the bioavailability of other protease inhibitors, requiring that the dose of the other protease inhibitors be reduced. Accordingly, the inclusion of ritonavir in the patient's treatment regimen may initiate a change in risk-group assignment, which in turn requires that diagnostic testing to evaluate the blood levels of other concomitantly administered protease inhibitors be done on a periodic basis.

Similarly, the addition of other drugs to the treatment regimen, either by the prescribing physician, or by another physician whom the patient might visit, may interfere with the initial treatment regimen prescribed by the registered prescriber 11. For example, AIDS patients often develop mycobacterial infections such as tuberculosis. An infectious disease specialist may prescribe one of a class of drugs known as rifamycins, such as rifampin or rifabutin, to treat such infections. Rifamycins are known to accelerate the metabolism of many protease inhibitors, however, so that upon initiation of treatment with a rifamycin, the effectiveness of the protease inhibitors may be greatly reduced, unless the dosage of those drugs is adjusted appropriately. Thus, when the patient is being treated with a protease inhibitor, the survey may include, for example, questions regarding the possible concurrent use of a rifamycin. If the survey results indicate that the two types of drugs are being used concurrently, the patient's risk group assignment is changed, such that the patient may be referred back to the prescriber 11 for an adjustment in dosage, or the patient may be directed to undergo diagnostic testing to assure that a sufficient level of the protease inhibitor is still being maintained. Similarly, where the registered prescriber 11 adds a prescription for a rifamycin to the treatment regimen of a registered patient who is also receiving a protease inhibitor, entry of the prescription into the system 14 may trigger an automatic change in risk group assignment, such that approval of the prescription will not be generated without further modification of the dosage of the protease inhibitor. In this way, the methods of the present invention may be advantageously utilized to maintain the proper dosing of one or more drugs, to minimize the likelihood of the occurrence of an adverse side effect from the concomitant use of such drugs, or the addition of other drugs to a treatment regimen, to encourage proper disclosure of the risks associated with the taking of one or more drugs, to minimize the risk that a contraindicated individual will be exposed to the potentially hazardous drugs, and to assist in generating patient compliance with treatment protocols and avoidance of behavior known to increase the risk that the disease will be spread to others.

In other embodiments of the present invention, the methods disclosed herein may be employed, for example, where a patient is undergoing treatment for various diseases, disorders or conditions, including, for example, transfusion dependent anemia due to Low- or Intermediate-1-risk myelodysplastic syndromes (MDS) associated with a deletion 5q chromosomal abnormality with or without additional cytogenetic abnormalities and multiple myeloma. Such patients may be treated with a drug, including a tertatogenic, suspected teratogenic, or other hazardous drug, such as, for example, lenalidomide or thalidomide. In certain embodiments, patients undergoing treatment for multiple myeloma may be treated with lenalidomide or thalidomide in combination with another drug, such as, for example, dexamethasone, where the patient has received at least one prior therapy for multiple myeloma. By following the methods of the present invention, the patient may be authorized to receive and continue to receive lenalidomide or thalidomide, while the risk of adverse side effects from administration of lenalidomide or thalidomide may be minimized or avoided. Additionally, the methods of the present invention may be desirably and advantageously used to educate and reinforce the actions and behaviors of patients who are taking lenalidomide or thalidomide, as well as prescribers who prescribe the drug and pharmacies which dispense the drug.

In addition to the methods described above, in certain embodiments of the present invention, the delivery of lenalidomide or thalidomide to the patient may involve the following steps. To control the distribution of lenalidomide or thalidomide and minimize the risk that a patient will receive the drug who is not eligible to receive it, or minimize the risk that an adverse side effect will occur from taking it, lenalidomide or thalidomide will preferably only be available through a controlled distribution program (may be registered as consent requirement definition 46), as described above for teratogenic, suspected teratogenic, or other hazardous drugs and as further exemplified below. Under this program, as a prelude to prescribing and dispensing the drug to the patient, the prescriber 11, pharmacy 12, and patient are registered in the system 14, as described above. If the prescriber 11 is not registered in the system 14, the prescriber 11 will be ineligible to prescribe the drug. Similarly, if the pharmacy 12 is not registered in the system 14, the pharmacy 12 will be ineligible to dispense the drug. Likewise, if the patient is not registered in the system 14, he or she will be ineligible to receive the drug.

As with the methods of the present invention previously described, prior to a patient receiving a prescription for lenalidomide or thalidomide, the patient must receive counseling about the drug, including counseling, for example, on effective birth control, and the risks of developing cytopenias, pulmonary embolisms, and deep venous thrombosis, if applicable. In some embodiments, patient counseling will be performed by the physician. In other embodiments, patient counseling will be performed by both the physician and the pharmacist. The methods of the present invention preferably involve requiring the patient to fill out an informed consent form which is signed by the prescriber 11 as well as the patient. The prescriber 11 should retain a copy of the informed consent form for his/her records. Verification that the patient has given his/her informed consent may also be registered in the system 14. Preferably, this verification is provided by the prescriber 11, and may be included, for example, with the patient registration information and risk group assignment. It has surprisingly been found that by having the prescriber 11, rather than the pharmacy 12, verify the patient's informed consent, the methods of the present invention may operate more efficiently, leading to better compliance, and hence decreased risk that the adverse side effect will occur, may be achieved. The patient will also receive counseling on the risks associated with taking the drug. Such counseling may be conducted verbally or may be in written form. In some embodiments, the patient will be supplied with training materials, including, for example, the informed consent form, a medication guide, product information, product package inserts, educational brochures, a pamphlet describing the patient surveys, and information on emergency contraception. The training materials preferably will contain a drug supply log form for the patient to record the date and quantity of drug received. The training materials may also provide the patient with information from which to he or she can educate his or her spouse or partner on the risks associated with taking the drug and need to comply with proper dosing regimens.

With respect to counseling, in certain embodiments, a third party vendor may confirm through consultation of answers to initial and follow-up surveys that proper counseling occurred every 28 days. Generally speaking, in certain embodiments, completed surveys will be faxed to the third party vendor, who then confirms the answers and supplies a confirmation number, as described below, to a physician to write on the prescription. Alternatively, if the third party vendor determines that the answers to the survey are incomplete or indicate that the patient is ineligible to receive the drug, the third party vendor will contact the physician to cancel the patient's prescription. As another alternative, the survey may be conducted using an integrated voice response system wherein the third party vendor confirms the survey answers and supplies a confirmation number as described below, to a physician to write on the prescription.

By filling out and signing an informed consent form, the patient acknowledges that he or she understands the risks associated with taking lenalidomide or thalidomide. In the informed consent form, the patient preferably agrees to comply with the risk avoidance measures provided, and to behave in a manner which is consistent with the prescriber's counsel. In certain embodiments, by signing the informed consent form, the patient acknowledges his or her consent to participate in one or more clinical trials regarding distribution of the drug. In certain embodiments of the present invention, by signing the informed consent form, the patient also acknowledges that he or she has informed his or her partner or spouse that the patient is taking lenalidomide or thalidomide, that the patient has been provided education materials (said materials preferably available in a language of a patient's choice such as, for example, Arabic, Cambodian, Chinese, English, French, German, Greek, Italian, Japanese, Korean, Laotian, Polish, Portuguese, Russian, Spanish, or Vietnamese) about the risks associated or suspected with lenalidomide or thalidomide therapy and precautions necessary to prevent fetal exposure by both the patient and the spouse during lenalidomide or thalidomide therapy to the partner or spouse, and that the patient has discussed effective birth control options with the partner or spouse.

In the present embodiment, by filling out and signing the informed consent form, the patient also may acknowledges that he or she agrees to designate and/or educate a drug accountability person to act on his or her behalf. As used herein, the term “drug accountability person” refers, for example, to a family member, friend, or guardian of the patient, or nurse assisting the patient, who is educated on the risks associated with taking lenalidomide or thalidomide, including the risks that lenalidomide or thalidomide may cause human birth defects or death to an unborn baby and that appropriate birth control must be used, the risk of developing deep venous thrombosis and pulmonary embolisms, and for MDS patients, the signs and symptoms of cytopenias (including neutropenia and/or thrombocytopenia) and the need for routine blood tests.

As with the patient information, the drug accountability person will preferably will be registered in the system 14 as consented patient risk information 47, including, for example, the drug accountability person's name, address, phone number, and relationship to the patient. The drug accountability person will be educated on the risk associated with lenalidomide or thalidomide therapy, including the risks that lenalidomide or thalidomide may cause human birth defects or death to an unborn baby and that appropriate birth control must be used, the risk of developing deep venous thrombosis and pulmonary embolisms, and for MDS patients, the signs and symptoms of cytopenias (including neutropenia and/or thrombocytopenia) and the need for routine blood test. In some embodiments, the drug accountability person signs an informed consent form indicating that he or she has received counseling regarding the risks associated with lenalidomide or thalidomide therapy and that he or she agrees to assist the patient in taking lenalidomide or thalidomide consistent with prescription guidelines, assist in the patient in preventing diversion of the drug, assist the patient in returning the drug to a pharmacy 12, distributor, or manufacturer of the drug if the drug is no longer suitable for the patient, and/or to return the drug to a pharmacy 12, distributor, or manufacturer of the drug if the patient expires prior to using all of the drug. In some embodiments, it is contemplated that a patient may be unable to designate a drug accountability person. In such circumstances, the prescriber 11 may determine whether the patient is eligible to receive the drug in the absence of designating a drug accountability person.

The consent requirement review unit 39, determines, based on the parameters from the medical institution 11, with a predefined definition (as shown with reference numeral 44 to 46) stored in the data storage section 33, whether registration of the accountability person is needed to assist the patient in taking the drug, and if the registration of the accountability person is not included in the parameters despite such registration being required, issuing an alert to request the medical institution 11 to enter a consent for such registration.

Preferably, lenalidomide or thalidomide will be distributed by an entity through contract pharmacies. In certain embodiments, only a pharmacy 12 that has contracted with the distributor or manufacturer of the drug will be eligible to dispense the drug.

It is preferred that prescriptions for lenalidomide or thalidomide are faxed to the contract pharmacy 12 or delivered in person. As used herein, the term “contract pharmacy” refers to a pharmacy 12 that has contracted to distribute lenalidomide or thalidomide. In certain embodiments, a contract pharmacy 12 may be located at an academic medical center, a prison or correctional facility, a Health Maintenance Organization (“HMO”), or a governmental body or agency, such as, for example, the Department of Defense. In addition to the eligibility requirements described above for teratogenic, suspected teratogenic, or other hazardous drugs, pharmacists and/or nurses employed by such contract pharmacies will preferably be trained on how to educate and counsel patients on risk avoidance measures associated with lenalidomide or thalidomide therapy. In certain embodiments, pharmacists and/or nurses employed by such contract pharmacies will be certified by an entity to counsel patients and dispense lenalidomide or thalidomide. Pharmacists and/or nurses will be required to participate in training programs, including review of training modules that provide an overview of MDS and multiple myeloma. Pharmacists and/or nurses will also be required to attend didactic or web-based training programs prior to being authorized to dispense lenalidomide or thalidomide. In circumstances where a patient is counseled on the risks of taking lenalidomide or thalidomide by both the prescriber 11 and pharmacist and/or nurse, the pharmacist and/or nurse will preferably educate patients on risk avoidance measures associated with lenalidomide or thalidomide therapy, as described below.

As described previously with respect to teratogenic, suspected teratogenic, or other hazardous drugs, information will preferably be collected from the patient that may be probative of the risk that a known or suspected side effect may occur if lenalidomide or thalidomide is taken by the patient. This information may then be compared with a predefined set of risk parameters for the lenalidomide or thalidomide, which in turn define a plurality of risk groups, so that analysis of the information will permit assignment of the patient to at least one of the risk groups. Preferably, this risk group assignment is then also entered into the system 14. This assignment may be performed by the prescriber 11, who may then include the risk group assignment on the patient's registration card or form, or may be performed by another individual, such as a nurse, technician, office personnel, or pharmacist, who preferably interprets the information and assigns the patient to one of the risk groups, accordingly.

As discussed above, it is preferable that a plurality of risk groups, each based upon a predefined set of risk parameters, be established for lenalidomide or thalidomide. With respect to lenalidomide or thalidomide, for example, a first risk group may comprise adult females of child-bearing potential; a second risk group may comprise adult females not of child-bearing potential; a third risk group may comprise female children of child-bearing potential; a fourth risk group may comprise female children not of child-bearing potential; a fifth risk group may comprise adult males; and a sixth risk group may comprise male children.

As used herein, the term “female of child-bearing potential” refers to a sexually mature female who has not undergone a hysterectomy or bilateral oopherectomy, and who has not been naturally post-menopausal for at least twenty-four consecutive months. In certain embodiments, in order for a female of child-bearing potential to be eligible to receive a drug, she must agree, for example, to completely abstain from sexual intercourse, or to use two methods of effective birth control simultaneously for four weeks prior to beginning therapy with the prescribed drug, during therapy, during therapy interruptions, if any, and for four weeks after completion of therapy.

As used herein, the term “effective birth control” refers to the combination of at least one highly effective method of birth control with another highly effective method or an effective barrier method of birth control used simultaneously. As used herein, the term “highly effective method of birth control” refers to an intrauterine device, a hormonal method, such as pills, patches, injections, implants or rings, tubal ligation, and a partner's vasectomy. As used herein, the term “effective barrier method of birth control” refers to a male latex condom, cervical cap, and diaphragm.

Preferably, before a female of child-bearing potential is eligible to receive lenalidomide or thalidomide, she must have a negative pregnancy test, with a sensitivity of at least 50 mIU/ml, prior to receipt of her first prescription for lenalidomide or thalidomide, within 10 and 14 days prior to the first prescription, and within 24 hours of the first prescription. During the first month of therapy, females of child-bearing potential preferably must also have negative pregnancy tests weekly for four weeks. Preferably, after the first month of therapy, females of child-bearing potential will receive monthly pregnancy tests, if she has regular menses, or twice monthly pregnancy tests if menses is irregular. In addition, if a patient misses her period, or has unusual menstrual bleeding during therapy, treatment with lenalidomide or thalidomide should preferably be discontinued and the patient should consult with her physician. In one embodiment, before receiving a prescription for lenalidomide or thalidomide, the prescriber 11 confirms that the patient is not pregnant. In another embodiment, before receiving a prescription for lenalidomide or thalidomide, the prescriber 11 and the pharmacist confirm that the patient is not pregnant.

Preferably, all female patients must refrain from breastfeeding and donating blood during lenalidomide or thalidomide therapy and for four weeks after completing therapy. All female patients must agree not to share the drug with anyone and must participate in mandatory, confidential surveys.

Preferably, a male patient must agree to use latex condoms every time he has sexual intercourse with a female of child bearing potential and for four weeks after completing lenalidomide or thalidomide therapy, even if he has undergone a successful vasectomy. Male patients must also agree to tell his healthcare provider if he has sexual intercourse without using a latex condom and if his partner may be pregnant. In addition, male patients must refrain from donating blood or sperm during therapy and for four weeks after completing therapy. All male patients must agree not to share the drug with anyone.

Preferably, for non-adult patients, i.e., children under the age of 18, the parent or guardian of the patient, will receive education and counseling about the risks associated with the drug, and instructions not to share the drug with anyone. For sexually active children, the pharmacist and/or physician should preferably discuss birth control options with the patient and parent or guardian of the patient as described above for adult patients. For non-sexually active children, the parent or guardian must agree to notify the healthcare provider, including the prescriber 11 or pharmacist, if a female patient begins menses.

Preferably, for an incompetent adult patient, an authorized representative must receive education and counseling about the risks associated with the drug, and instructions not to share the drug with anyone on behalf of the incompetent adult patient. The authorized representative may be, for example, a relative, spouse, family member, friend, guardian, or caretaker who is authorized under applicable state laws to consent to treatment on the incompetent patient's behalf. The authorized representative must read all educational material, initial the informed consent forms, and agree to ensure compliance. For incompetent adult patients, the prescriber 11 must also submit a signed and dated letter on the prescriber's letterhead, stating that the incompetent patient lacks the capacity to complete the informed consent form, identifying the medical condition causing the incapacity, the name and address of the authorized representative and relationship to the patient, and an opinion that the authorized representative accepts responsibility for the patient's compliance with the program and is authorized to consent to treatment on the patient's behalf.

All patients will preferably be counseled to use appropriate contraception to prevent fetal exposure to the drug. In addition, patients will preferably be counseled on the risks of developing neutropenia and thrombocytopenia from lenalidomide treatment (or other treatment) for MDS. Such patients will preferably get complete blood counts (CBCs) weekly during the first eight weeks of therapy and at least monthly thereafter.

In certain embodiments, patients may be assigned to an obstetrician/gynecologist (“OB/GYN”). In such cases, the OB/GYN may provide additional counseling to the patient regarding contraceptive measures. In certain cases, the OB/GYN may provide emergency contraception to a patient taking lenalidomide or thalidomide who thinks she may be pregnant or to a woman who may have been impregnated by a male patient taking lenalidomide or thalidomide. If an OB/GYN is designated for a patient, the OB/GYN may be registered in a system 14. Registration may include the OB/GYN's name, address, and affiliation, if any, with one or more health care institutions. In certain embodiments, the prescriber 11 will identify an OB/GYN for the patient to handle patient inquires concerning, for example, emergency contraception, additional patient counseling, pregnancy testing, and positive pregnancy results.

In certain embodiments of the invention, counseling may be undertaken by a pharmacist, doctor, nurse, or other health care professional at a contract pharmacy 12, either by phone or in person.

For patients being treated with lenalidomide (or another drug) for multiple myeloma, patients may optionally get CBCs every two weeks for the first twelve weeks of treatment and then monthly thereafter. Such patients should preferably be counseled on the risk of developing deep venous thrombosis and pulmonary embolism. All patients should be counseled not to share lenalidomide (or another drug) with anyone.

In certain embodiments, pharmacists and/or nurses will preferably contact patients who have been prescribed lenalidomide or thalidomide prior to shipping or filling a prescription for it. During this phone or in-person contact, patients will preferably be counseled, as describe above, that lenalidomide or thalidomide may cause human birth defects or death to an unborn baby, appropriate birth control must be used, the risk of developing deep venous thrombosis and pulmonary embolisms, and for MDS patients, the signs and symptoms of cytopenias (including neutropenia and/or thrombocytopenia) and the need for routine blood tests. Prior to dispensing lenalidomide or thalidomide, the pharmacist or nurse will confirm that the patient understands the risks of the drug. The pharmacist or nurse will also verify the patient's shipping address, if necessary. Preferably, the pharmacist does not ship or dispense lenalidomide or thalidomide to a patient until an authorization number is verified with the system 14 and a confirmation number is issued to the pharmacist from the system 14, and the pharmacist or nurse has counseled the patient, as described above.

As used herein, the term “authorization number” refers to a number issued to the physician from the system 14 after the completion of patient counseling by the physician, the patient survey by the patient, and the physician survey by the physician. Once the physician obtains the authorization number, it is written on the prescription. In certain embodiments, the authorization number is valid only for a limited time starting from the day the physician obtains the authorization number, such as, for example, seven or 14 days for females of child-bearing potential, or 14 days for patients not of child-bearing potential. In certain embodiments, in addition to the authorization number, the physician will also be issued a “must ship/dispense by date,” which is preferably also written on the prescription. The “must ship/dispense by date” refers to the date by which a pharmacy 12 must either counsel the patient as to the risks associated with the prescribed drug, as discussed above, and ship the drug to the patient; or counsel the patient as to the risks associated with the prescribed drug, as discussed above, and dispense the drug to the patient.

As used herein, the term “confirmation number” refers to a verification number that the system 14 at the marketer or distributor of a drug preferably provides to the pharmacist when the pharmacist calls or otherwise contacts, including via on-line or web-based transmission, the system to verify the authorization number. The confirmation number may also be supplied by a third party vendor to the physician after verifying patient compliance through survey answers. Preferably, the confirmation number is valid for 24 hours after the pharmacist or physician obtains the confirmation number. In preferred embodiments, the pharmacy 12 ships or provides lenalidomide or thalidomide within the time the confirmation number is valid (i.e., within 24 hours). If the drug is not shipped or picked up within the 24 hour time frame, the pharmacy 12 will cancel the confirmation number and obtain a new confirmation number when it is ready to ship the drug or have it picked up. In certain embodiments, when the pharmacist contacts the system 14 at the marketer or distributor to verify the authorization number, the pharmacist receives, in addition to the confirmation number, an indication as to the number of days the prescription is valid for, such that the pharmacist is informed of the of the number days remaining in which the prescription can be filled.

Prior to being provided a confirmation number, in certain embodiments the pharmacist must confirm that the pharmacy 12 has the drug in stock and ready to dispense. If the pharmacy 12 does not currently have the drug in stock at the time that the pharmacist seeks to obtain the confirmation number, a confirmation number will not be provided and the pharmacy 12 will not be authorized to dispense the drug.

The pharmacy 12 may seek to obtain supply of the drug. It is contemplated that a pharmacy 12 may request transfer of the drug to it from another pharmacy 12. In certain embodiments, a retail pharmacy 12 that is a member of a chain of pharmacies may request that the drug be transferred to it from another pharmacy 12 that is apart of the same pharmacy chain. The drug can then be shipped or otherwise transferred to the pharmacy 12 that seeks to dispense it. Preferably, the drug transferred is from the transferor-pharmacy's most recently received inventory.

Alternatively, a pharmacy 12 may request transfer of the drug to it from any other pharmacy 12. Preferably, the drug transferred is from the transferor-pharmacy's most recently received inventory. In other embodiments, the drug transferred is from the transferor-pharmacy's stored inventory.

In certain embodiment, lenalidomide, thalidomide or other hazardous drug will be distributed and dispensed through an exclusive central pharmacy 12. In such cases, the central pharmacy 12 will act in place of the contract pharmacy 12, and in addition to the role described for the contract pharmacy 12, will contact the prescriber 11 to verify the prescriber's eligibility to prescribe the drug. The central pharmacy 12 will also perform patient counseling on the risks of taking the drug and risk avoidance measures. The central pharmacy 12 will preferably ship the drug to the patient's home and will confirm by follow-up telephone call that the drug has been received by the patient.

It certain embodiments, it may be preferable to educate a patient as to the existence of one or more pharmacies registered to dispense the teratogenic, suspected teratogenic, or other hazardous drug. Registered prescribers may be supplied with a list of registered pharmacies, which list may then be supplied to the patient. In certain embodiments, the list of registered pharmacies may include, for example, those pharmacies that are located within 15 miles or less to the prescriber 11 and/or patient. In other embodiments, the list of registered pharmacies may include, for example, those pharmacies located within the same state, region, or territory as the prescriber 11 and/or patient. In other embodiments, the list of registered pharmacies may include, for example, those registered pharmacies that have dispensed the teratogenic, suspected teratogenic, or other hazardous drug within the preceding 12 months. Still in other embodiments, the list of registered pharmacies may include, for example, all registered pharmacies. One skilled in the art will readily appreciate that a list of registered pharmacies may include a list of pharmacies in any or all of the foregoing categories.

As noted above for other teratogenic drugs and drugs suspected of being teratogenic, lenalidomide or thalidomide is preferably prescribed and dispensed to the patient in a limited amount, with a prescription amount of no more than about 28 days being preferred, and preferably with no refills being permitted. Preferably, a new prescription is required for subsequent dispensations of the drug and a subsequent prescription will not be dispensed unless there are seven days or less remaining on the current prescription. Thus, for the patient to obtain an additional prescription, it is generally necessary for the patient to have a follow-up visit with the prescriber 11. Such a follow-up visit preferably takes place at least each time the patient requires a renewal of the prescription, and possibly more often if the patient requires, for example, additional counseling. At the follow-up visit, the patient will preferably receive additional counseling regarding the risks and benefits associated with taking the drug, as well as further counseling on birth control (if applicable). The patient will also preferably complete an additional patient survey to provide current information regarding their lifestyle, including their sexual behavior and, if female of childbearing potential, be administered a new pregnancy test. In some embodiments, certain patients may need only complete a follow-up survey after every six months of therapy. Such patients may include males and females of non-child bearing potential. The additional patient survey may be administered to the patient in a variety of ways, including by telephone, by facsimile, through the use of an integrated voice response system, and/or through a web-based system. After receiving the counseling and completing the patient survey, and if the pregnancy tests for female patients are negative, the prescriber 11 may fill out a new prescription for the drug. As with the original prescription, the renewal prescription is preferably for a limited period of time, with no more than about 28 days being more preferred. If the survey results reveal that the patient is not complying with the prescribing guidelines, preferably a representative from a marketer or distributor of a drug, will contact prescriber 11 and inform the prescriber 11 of the survey results. If therapy is discontinued for twelve consecutive months, in order for the patient to receive a new prescription for lenalidomide or thalidomide, he or she must re-register in the program as previously described.

It is to be appreciated, of course, that one or more of the methods of the present invention may be accomplished by means of one or more computer systems. Accordingly, in certain embodiments, the invention comprises a computer system capable of automating one or more steps of the methods disclosed herein. Such a computer system may comprise, in certain embodiments of the invention, one or more of an input/output means, means for storing data regarding the patient, the prescriber 11, and the drug, means for communicating data over an internal or external network, means for communicating data over the internet, and means (interactive, in certain embodiments) for providing patient, prescriber 11, or drug accountability person with education regarding a drug or a drug's safe and effective use.

Other embodiments of the invention comprise an online management system that may itself comprise one or more of a web server, a database server, and an email server and through which any of the above disclosed embodiments can be implemented.

For example, a web server (including a server administered by the manufacturer or distributor of a drug) may provide for the generation of registration information, such as prescriber, patient, and pharmacist registrations. For example, the web server may interface with a network such as the Internet to provide interaction between an electronic device operated by a user and one or more interfaces such as web pages that may be provided by the web server. As used herein, the term “user” means a prescriber, patient, and/or pharmacist. The web server may comprise hardware components such as processors, storage modules, communication components, or the like and software components such as operating systems, Web-based management applications, or the like such that the web server may be adapted to store user information by the online management system. The web server may also serve to interact and interface with the other functional components of the online management system including a database server.

In one embodiment, the web server may present Web-based interfaces, using, for example, Hypertext Transfer Protocol (HTTP) and/or Secure Hypertext Transfer Protocol (HTTP/S) protocols, to the user via the electronic device. For example, the web server may provide an interface to handle the submission of registration information that is provided by or on behalf of the user. The web server may also provide an interface to the user for the submission of user surveys (including the patient and prescriber surveys, such as, but not limited to, surveys to access a patient's risk group assignment), access to a prescription form that may be completed by a prescriber to prescribe a drug for a patient, and the submission of informed consent forms by a patient.

The online management system may further include a database server. The database server may be configured to store information received via the interfaces hosted by the web server, and to make this information accessible to a user. For example, the database server may be configured to store a profile for each patient that may be registered by the user. The database server may include, for example, any suitable hardware component designed to store data such as personal information, medical history, risk group assignment, or the like.

### EXAMPLES

The following shows the examples of the patient parameters 44 and the consented patient information 47 that may be used in the embodiments of the invention. The patient parameters 44, for example, may be gathered by a prescriber in the form of patient surveys and assessments, and sent to the system 14. The patient parameters and the patient risk groups are defined based on the types of drugs. The system 14 is configured to determine based on the patient parameters whether a patient understands the risks associated with taking a drug, whether a prescriber is making assessments by satisfying necessary steps, and whether a pharmacy is registered, thereby issuing a prescription approval code and a permission code for filling a drug prescription.

### Example 1

### Initial Patient Survey for Female Children not of Childbearing Potential

The following survey (or comparable survey) may be used at assist in the gathering of information from a female child not of childbearing potential, at an initial patient interview.

1. Initial Patient Survey
For Female Children NOT of Childbearing Potential

| | |
|---|---|
| 1-1. | Has the child in your care reached puberty and/or started her |
| | menstrual periods? |

| | | |
|---|---|---|
| Yes | No | Don't Know |

| | |
|---|---|
| 1-2. | In the past 4 weeks, has this female patient had sexual intercourse |
| | with a male partner? |

| | | |
|---|---|---|
| Yes | No | Don't Know |

### Example 2

### Initial Patient Survey for Female Children of Childbearing Potential

The following survey (or comparable survey) may be used at assist in the gathering of information from a patient, wherein the patient is a female child of childbearing potential, at an initial patient interview.

2. Initial Patient Survey
For Female Children of Childbearing Potential

| | |
|---|---|
| 2-1. | Do you agree not to shared the Drug A with anyone? |

| | | |
|---|---|---|
| Yes | No | Don't Know |

| | |
|---|---|
| 2-2. | Do you agree not to donate to a blood bank while taking Drug A? |

| | | |
|---|---|---|
| Yes | No | Don't Know |

| | |
|---|---|
| 2-3. | In the past 4 weeks, have you had sexual intercourse with a |
| | male partner? |

| | | |
|---|---|---|
| Yes | No | Don't Know |

| | |
|---|---|
| 2-4. | Do you agree to use at least 2 of the recommended forms of birth |
| | control for at least the last 4 months? |

| | | |
|---|---|---|
| Yes | No | Don't Know |

| | |
|---|---|
| 2-5. | On any occasion during the last 4 weeks, have you had sexual |
| | intercourse without using 2 forms of birth control? |

| | | |
|---|---|---|
| Yes | No | Don't Know |

| | |
|---|---|
| 2-6. | Do you have any reason to suspect that you may be pregnant? |

| | | |
|---|---|---|
| Yes | No | Don't Know |

### Example 3

### Initial Patient Survey for Male Children

The following survey (or comparable survey) may be used at assist in the gathering of information from a patient, wherein the patient is a male child, at an initial patient interview.

3. Initial Patient Survey
For Male Children

| | |
|---|---|
| 3-1. | Do you agree not to share the Drug A with anyone? |

| | | |
|---|---|---|
| Yes | No | Don't Know |

| | |
|---|---|
| 3-2. | Do you agree not to donate to a blood or sperm bank while taking |
| | Drug A? |

| | | |
|---|---|---|
| Yes | No | Don't Know |

| | |
|---|---|
| 3-3. | Are you sexually active with a woman of childbearing potential, |
| | is pregnant, or could become pregnant? |

| | | |
|---|---|---|
| Yes | No | Don't Know |

| | |
|---|---|
| 3-4. | While taking Drug A, do you agree to use a latex condom EVERY |
| | time you engage in sexual activity with a female who is or could |
| | become pregnant? |

| | | |
|---|---|---|
| Yes | No | Don't Know |

### Example 4

### Initial Prescriber Survey for Female Children Not of Childbearing Potential

The following survey (or comparable survey) may be used at assist in the gathering of information from a prescriber, wherein the prescriber's patient is a female child not of childbearing potential, at an initial patient interview.

4. Initial Prescriber Survey
For Female Children NOT of Childbearing Potential

| | |
|---|---|
| 4-1. | Has the child reached puberty and/or started her menstrual periods? |

| | | |
|---|---|---|
| Yes | No | Don't Know |

| | |
|---|---|
| 4-2. | What is the Average Daily Dose of Drug A per Day that you are |
| | prescribing for this patient on today's prescription? |

| | |
|---|---|
| 4-3. | What is the total number of days' supply you are going to write for |
| | on today's prescription? |

### Example 5

### Initial Prescriber Survey for Female Children of Childbearing Potential

The following survey (or comparable survey) may be used at assist in the gathering of information from a prescriber, wherein the prescriber's patient is a female child of childbearing potential, at an initial patient interview.

5. Initial Prescriber Survey
For Female Children of Childbearing Potential

| | |
|---|---|
| 5-1. | Do you agree to do pregnancy testing on this patient in accordance |
| | with the Program A requirements? |

| | | |
|---|---|---|
| Yes | No | Don't Know |

| | |
|---|---|
| 5-2. | What is the date of the most recent pregnancy test? |

| | |
|---|---|
| 5-3. | Were the results of either pregnancy test positive? |

| | | |
|---|---|---|
| INCONCL/PENDING | POSITIVE | NEGATIVE |

| | |
|---|---|
| 5-4. | What is the Average Daily Dose of Drug A per Day that you are |
| | prescribing for this patient on today's prescription? |

| | |
|---|---|
| 5.6 | What is the total number of days' supply you are going to write for |
| | on today's prescription? |

### Example 6

### Initial Prescriber Survey for Male Children

The following survey (or comparable survey) may be used at assist in the gathering of information from a prescriber, wherein the prescriber's patient is a male child, at an initial patient interview.

6. Initial Prescriber Survey
For Male Children

| | |
|---|---|
| 6-1. | What is the Average Daily Dose of Drug A per Day that you are |
| | prescribing for this patient on today's prescription? |

| | |
|---|---|
| 6-2. | What is the total number of days' supply you are going to write for |
| | on today's prescription? |

### Example 7

### Follow-Up Patient Survey for Female Children of Childbearing Potential

The following survey (or comparable survey) may be used at assist in the gathering of information from a female child patient of childbearing potential, at a follow-up patient interview.

7. Follow-up Patient Survey
For Female Children of Childbearing Potential
(to be completed every month)

| | |
|---|---|
| 7-1. | Has the patient shared her Drug A with anyone? |

| | | |
|---|---|---|
| Yes | No | Don't Know |

| | |
|---|---|
| 7-2. | Has the patient donated to a blood bank while taking Drug A? |

| | | |
|---|---|---|
| Yes | No | Don't Know |

| | |
|---|---|
| 7-3. | In the past 4 weeks, has the patient had sexual intercourse with a |
| | male partner? |

| | | |
|---|---|---|
| Yes | No | Don't Know |

| | |
|---|---|
| 7-4. | Has the patient been using at least 2 of the recommended forms of |
| | birth control during the past 4 weeks? |

| | | |
|---|---|---|
| Yes | No | Don't Know |

| | |
|---|---|
| 7-5. | On any occasion during the last 4 weeks, has the patient had |
| | sexual intercourse without using 2 forms of birth control? |

| | | |
|---|---|---|
| Yes | No | Don't Know |

| | |
|---|---|
| 7-6. | Do you have any reason to suspect that this patient may be |
| | pregnant? |

| | | |
|---|---|---|
| Yes | No | Don't Know |

### Example 8

### Follow-Up Patient Survey for Female Children not of Childbearing Potential

The following survey (or comparable survey) may be used at assist in the gathering of information from a female child patient not of childbearing potential, at a follow-up patient interview.

8. Follow-up Patient Survey
For Female Children NOT of Childbearing Potential
(to be completed every month)

| | |
|---|---|
| 8-1. | Has the patient shared her Drug A with anyone? |

| | | |
|---|---|---|
| Yes | No | Don't Know |

| | |
|---|---|
| 8-2. | Has the patient donated to a blood bank while taking Drug A? |

| | | |
|---|---|---|
| Yes | No | Don't Know |

| | |
|---|---|
| 8-3. | Has the child in your care reached puberty and/or started her |
| | menstrual periods? |

| | | |
|---|---|---|
| Yes | No | Don't Know |

| | |
|---|---|
| 8-4. | In the past 4 weeks, has this female patient had sexual intercourse |
| | with a male partner? |

| | | |
|---|---|---|
| Yes | No | Don't Know |

### Example 9

### Follow-Up Patient Survey for Male Children

The following survey (or comparable survey) may be used at assist in the gathering of information from a male child, at a follow-up patient interview.

9. Follow-up Patient Survey
For Male Children
(to be completed every month)

| | |
|---|---|
| 9-1. | Has the patient shared his Drug A with anyone? |

| | | |
|---|---|---|
| Yes | No | Don't Know |

| | |
|---|---|
| 9-2. | Has the patient donated to a blood or sperm bank while taking |
| | Drug A? |

| | | |
|---|---|---|
| Yes | No | Don't Know |

| | |
|---|---|
| 9-3. | Has the patient been sexually active with a woman who has her |
| | womb, is pregnant, or could become pregnant? |

| | | |
|---|---|---|
| Yes | No | Don't Know |

| | |
|---|---|
| 9-4. | While taking Drug A, has the patient used a latex condom EVERY |
| | time he has engaged in sexual activity with a female who is or |
| | could become pregnant? |

| | | |
|---|---|---|
| Yes | No | Don't Know |

### Example 10

### Follow-Up Prescriber Survey for Female Children not of Childbearing Potential

The following survey (or comparable survey) may be used at assist in the gathering of information from a prescriber, wherein the prescriber's patient is a female child not of childbearing potential, at a follow-up patient interview.

10. Follow-up Prescriber Survey
For Female Children NOT of Childbearing Potential
(to be completed every month)

| | |
|---|---|
| 10-1. | Have you reminded the patient or her guardian that she must not |
| | share her Drug A with any other person? |

| | | |
|---|---|---|
| Yes | No | Don't Know |

| | |
|---|---|
| 10-2. | Have you reminded the patient or her guardian that she must not |
| | donate to a blood bank while taking Drug A? |

| | | |
|---|---|---|
| Yes | No | Don't Know |

| | |
|---|---|
| 10-3. | Has the child reached puberty and/or started her menstrual |
| | periods? |

| | | |
|---|---|---|
| Yes | No | Don't Know |

| | |
|---|---|
| 10-4. | What is the Average Daily Dose of Drug A per Day that you are |
| | prescribing for this patient on today's prescription? |

| | |
|---|---|
| 10-5. | What is the total number of days' supply you are going to write for |
| | on today's prescription? |

### Example 11

### Follow-Up Prescriber Survey for Female Children of Childbearing Potential

The following survey (or comparable survey) may be used at assist in the gathering of information from a prescriber, wherein the prescriber's patient is a female child of childbearing potential, at a follow-up patient interview.

11. Follow-up Prescriber Survey
For Female Children of Childbearing Potential
(to be completed every month)

| | |
|---|---|
| 11-1. | Have you reminded the patient or her guardian that she must not |
| | share her Drug A with any other person? |

| | | |
|---|---|---|
| Yes | No | Don't Know |

| | |
|---|---|
| 11-2. | Have you reminded the patient or her guardian that she must not |
| | donate to a blood bank while taking Drug A? |

| | | |
|---|---|---|
| Yes | No | Don't Know |

| | |
|---|---|
| 11-3. | Have you counseled the patient or her guardian regarding the |
| | appropriate use of contraception during Drug A therapy? |

| | | |
|---|---|---|
| Yes | No | Don't Know |

| | |
|---|---|
| 11-4. | Has the patient had their womb or uterus surgically removed |
| | since beginning Drug A therapy? |

| | | |
|---|---|---|
| Yes | No | Don't Know |

| | |
|---|---|
| 11-5. | Has the patient experienced a natural menopause for at least 24 |
| | months? |

| | | |
|---|---|---|
| Yes | No | Don't Know |

| | |
|---|---|
| 11-6. | What is the date of the most recent pregnancy test? |

| | |
|---|---|
| 11-7. | What was the result of the pregnancy test? |

| | | |
|---|---|---|
| INCONCL/PENDING | POSITIVE | NEGATIVE |

| | |
|---|---|
| 11-8. | What is the Average Daily Dose of Drug A per Day that you are |
| | prescribing for this patient on today's prescription? |

| | |
|---|---|
| 11-9. | What is the total number of days' supply you are going to write for |
| | on today's prescription? |

### Example 12

### Follow-Up Prescriber Survey for Male Children

The following survey (or comparable survey) may be used at assist in the gathering of information from a prescriber, wherein the prescriber's patient is a male child, at a follow-up patient interview.

12. Follow-up Prescriber Survey
For Male Children
(to be completed every month)

| | |
|---|---|
| 12-1. | Have you reminded the patient or his guardian that he must not |
| | share his Drug A with any other person? |

| | | |
|---|---|---|
| Yes | No | Don't Know |

| | |
|---|---|
| 12-2. | Have you reminded the patient or his guardian that he must |
| | not donate to a blood or sperm bank while taking Drug A? |

| | | |
|---|---|---|
| Yes | No | Don't Know |
| Yes | No | Don't Know |

| | |
|---|---|
| 12-3. | Have you reminded the patient or his guardian that a latex |
| | condom must be used EVERY time he engages in any sexual |
| | activity with a female who is or could become pregnant? |

| | | |
|---|---|---|
| Yes | No | Don't Know |

| | |
|---|---|
| 12-4. | What is the Average Daily Dose of Drug A per Day that you |
| | are prescribing for this patient on today's prescription? |
| 12-5. | What is the total number of days' supply you are going to write for |
| | on today's prescription? |

### Example 13

### Initial Patient Survey for Adult Females not of Childbearing Potential

The following survey (or comparable survey) may be used at assist in the gathering of information from a patient, wherein the patient is a female adult not of childbearing potential, at an initial patient interview.

13. Initial Patient Survey
For Adult Females NOT of Childbearing Potential

| | |
|---|---|
| 13-1. | Have you had your womb or uterus surgically removed? |

| | | |
|---|---|---|
| Yes | No | Don't Know |

| | |
|---|---|
| 13-2. | Have your menstrual periods stopped naturally for more than 24 |
| | months? |

| | | |
|---|---|---|
| Yes | No | Don't Know |

### Example 14

### Initial Patient Survey for Adult Females of Childbearing Potential

The following survey (or comparable survey) may be used at assist in the gathering of information from a patient, wherein the patient is a female adult of childbearing potential, at an initial patient interview.

14. Initial Patient Survey
For Adult Females of Childbearing Potential

| | |
|---|---|
| 14-1. | In the past 4 weeks, have you had sexual intercourse with a male |
| | partner? |

| | | |
|---|---|---|
| Yes | No | Don't Know |

| | |
|---|---|
| 14-2. | Have you been using at least 2 of the recommended forms of birth |
| | control for at least the last 4 weeks? |

| | | |
|---|---|---|
| Yes | No | Don't Know |

| | |
|---|---|
| 14-3. | On any occasion during the last 4 weeks, have you had sexual |
| | intercourse without using 2 forms of birth control? |

| | | |
|---|---|---|
| Yes | No | Don't Know |

| | |
|---|---|
| 14-4. | Do you have any reason to suspect that you may be |
| | pregnant? |

| | | |
|---|---|---|
| Yes | No | Don't Know |

### Example 15

### Initial Patient Survey for Adult Males

The following survey (or comparable survey) may be used at assist in the gathering of information from a patient, wherein the patient is an adult male, at an initial patient interview.

15. Initial Patient Survey
For Adult Males

| | |
|---|---|
| 15-1. | Do you agree not to share your Drug A with anyone? |

| | | |
|---|---|---|
| Yes | No | Don't Know |

| | |
|---|---|
| 15-2. | Do you agree not to donate to a blood or sperm bank while taking |
| | Drug A? |

| | | |
|---|---|---|
| Yes | No | Don't Know |

| | |
|---|---|
| 15-3. | Are you sexually active with a woman who has her womb, is |
| | pregnant, or could become pregnant? |

| | | |
|---|---|---|
| Yes | No | Don't Know |

| | |
|---|---|
| 15-4. | While taking Drug A, do you agree to use a latex condom EVERY |
| | time you have engaged in sexual activity with a female who is or |
| | could become pregnant? |

| | | | |
|---|---|---|---|
| Yes | No | Don't Know | Abstain |

### Example 16

### Initial Prescriber Survey for Adult Females not of Childbearing Potential

The following survey (or comparable survey) may be used at assist in the gathering of information from a prescriber, wherein the patient is a female adult not of childbearing potential, at an initial patient interview.

16. Initial Prescriber Survey
For Adult Females NOT of Childbearing Potential

| | |
|---|---|
| 16-1. | Has the patient had their womb or uterus surgically removed? |

| | | |
|---|---|---|
| Yes | No | Don't Know |

| | |
|---|---|
| 16-2. | Has the patient been in natural menopause for at least 24 |
| | months? |

| | | |
|---|---|---|
| Yes | No | Don't Know |

| | |
|---|---|
| 16-3. | What is the Average Daily Dose of Drug A per Day that you |
| | are prescribing for this patient on today's prescription? |

| | |
|---|---|
| 16-4. | What is the total number of days' supply you are going to write for |
| | on today's prescription? |

### Example 17

### Initial Patient Survey for Adult Females of Childbearing Potential

The following survey (or comparable survey) may be used at assist in the gathering of information from a prescriber, wherein the patient is a female adult of childbearing potential, at an initial patient interview.

17. Initial Prescriber Survey
For Adult Females of Childbearing Potential

| | |
|---|---|
| 17-1. | Do you agree to do pregnancy testing on this patient in |
| | accordance with the Program A requirements? |

| | | |
|---|---|---|
| Yes | No | Don't Know |

| | |
|---|---|
| 17-2. | What is the date of the most recent pregnancy test? |

| | |
|---|---|
| 17-3. | Were the results of either pregnancy test positive? |

| | | |
|---|---|---|
| INCONCL/PENDING | NEGATIVE | POSITIVE |

| | |
|---|---|
| 17-4. | What is the Average Daily Dose of Drug A per Day that you are |
| | prescribing for this patient on today's prescription? |

| | |
|---|---|
| 17-5. | What is the total number of days' supply you are going to write for |
| | on today's prescription? |

### Example 18

### Initial Prescriber Survey for Adult Males

The following survey (or comparable survey) may be used at assist in the gathering of information from a prescriber, wherein the patient is an adult male, at an initial patient interview.

18. Initial Prescriber Survey
For Adult Males

| | |
|---|---|
| 18-1. | What is the Average Daily Dose of Drug A per Day that you are |
| | prescribing for this patient on today's prescription? |

| | |
|---|---|
| 18-2. | What is the total number of days' supply you are going to write for |
| | on today's prescription? |

### Example 19

### Follow-Up Patient Survey for Adult Females not of Childbearing Potential

The following survey (or comparable survey) may be used at assist in the gathering of information from a patient, wherein the patient is a female adult not of childbearing potential, at a follow-up patient interview.

19. Follow-up Patient Survey
For Adult Females NOT of Childbearing Potential
(to be completed every 6 months)

| | |
|---|---|
| 19-1. | Have you shared your Drug A with anyone? |

| | | |
|---|---|---|
| Yes | No | Don't Know |

| | |
|---|---|
| 19-2. | Have you donated to a blood bank while taking Drug A? |

| | | |
|---|---|---|
| Yes | No | Don't Know |

### Example 20

### Follow-Up Patient Survey for Adult Females of Childbearing Potential

The following survey (or comparable survey) may be used at assist in the gathering of information from a patient, wherein the patient is a female adult of childbearing potential, at a follow-up patient interview.

20. Follow-up Patient Survey
For Adult Females of Childbearing Potential
(to be completed every month)

| | |
|---|---|
| 20-1. | Have you ever shared your Drug A with anyone? |

| | | |
|---|---|---|
| Yes | No | Don't Know |

| | |
|---|---|
| 20-2. | Have you donated to a blood bank while taking Drug A? |

| | | |
|---|---|---|
| Yes | No | Don't Know |

| | |
|---|---|
| 20-3. | Have you had your womb or uterus surgically removed? |

| | | |
|---|---|---|
| Yes | No | Don't Know |

| | |
|---|---|
| 20-4. | Have your menstrual periods stopped naturally for more than 24 |
| | months? |

| | | |
|---|---|---|
| Yes | No | Don't Know |

| | |
|---|---|
| 20-5. | In the past 4 weeks, have you had sexual intercourse with a |
| | male partner? |

| | | |
|---|---|---|
| Yes | No | Don't Know |

| | |
|---|---|
| 20-6. | Have you been using at least 2 of the recommended forms of birth |
| | control during the last 4 weeks? |

| | | |
|---|---|---|
| Yes | No | Don't Know |

| | |
|---|---|
| 20-7. | On any occasion during the last 4 weeks, have you had sexual |
| | intercourse without using 2 forms of birth control? |

| | | |
|---|---|---|
| Yes | No | Don't Know |

| | |
|---|---|
| 20-8. | Do you have any reason to suspect that you may be pregnant? |

| | | |
|---|---|---|
| Yes | No | Don't Know |

### Example 21

### Follow-Up Patient Survey for Adult Males

The following survey (or comparable survey) may be used at assist in the gathering of information from a patient, wherein the patient is an adult male, at a follow-up patient interview.

21. Follow-up Patient Survey
For Adult Males
(to be completed every month)

| | |
|---|---|
| 21-1. | Have you shared your Drug A with anyone? |

| | | |
|---|---|---|
| Yes | No | Don't Know |

| | |
|---|---|
| 21-2. | Have you donated to a blood or sperm bank while taking Drug A? |

| | | |
|---|---|---|
| Yes | No | Don't Know |

| | |
|---|---|
| 21-3. | Are you sexually active with a woman who has her womb, is |
| | pregnant, or could become pregnant? |

| | | |
|---|---|---|
| Yes | No | Don't Know |

| | |
|---|---|
| 21-4. | While taking Drug A, have you used a latex condom EVERY time |
| | you have engaged in sexual activity with a female who is or could |
| | become pregnant? |

| | | | |
|---|---|---|---|
| Yes | No | Don't Know | Abstain |

### Example 22

### Follow-Up Prescriber Survey for Adult Females Not of Childbearing Potential

The following survey (or comparable survey) may be used at assist in the gathering of information from a prescriber, wherein the patient is a female adult not of childbearing potential, at a follow-up patient interview.

22. Follow-up Prescriber Survey
For Adult Females NOT of Childbearing Potential
(to be completed every month)

| | |
|---|---|
| 22-1. | Have you reminded the patient that she must not share her Drug A |
| | with any other person? |

| | | |
|---|---|---|
| Yes | No | Don't Know |

| | |
|---|---|
| 22-2. | Have you reminded the patient that she must not donate to a blood |
| | bank while taking Drug A? |

| | | |
|---|---|---|
| Yes | No | Don't Know |

| | |
|---|---|
| 22-3. | What is the Average Daily Dose of Drug A per Day that you are |
| | prescribing for this patient on today's prescription? |

| | |
|---|---|
| 22-4. | What is the total number of days' supply you are going to write for |
| | on today's prescription? |

### Example 23

### Follow-Up Prescriber Survey for Adult Females of Childbearing Potential

The following survey (or comparable survey) may be used at assist in the gathering of information from a prescriber, wherein the patient is a female adult of childbearing potential, at a follow-up patient interview.

23. Follow-up Prescriber Survey
For Adult Females of Childbearing Potential
(to be completed every month)

| | |
|---|---|
| 23-1. | Have you reminded the patient or her guardian that she must not |
| | share her Drug A with any other person? |

| | | |
|---|---|---|
| Yes | No | Don't Know |

| | |
|---|---|
| 23-2. | Have you reminded the patient or her guardian that she must not |
| | donate to a blood bank while taking Drug A? |

| | | |
|---|---|---|
| Yes | No | Don't Know |

| | |
|---|---|
| 23-3. | Have you counseled the patient or her guardian regarding |
| | the appropriate use of contraception during Drug A therapy? |

| | | |
|---|---|---|
| Yes | No | Don't Know |

| | |
|---|---|
| 23-4. | Has the patient had their womb or uterus surgically removed since |
| | beginning Drug A therapy? |

| | | |
|---|---|---|
| Yes | No | Don't Know |

| | |
|---|---|
| 23-5. | Has the patient experienced a natural menopause for at least |
| | 24 months? |

| | | |
|---|---|---|
| Yes | No | Don't Know |

| | |
|---|---|
| 23-6. | What is the date of the most recent pregnancy test? |

| | |
|---|---|
| 23-7. | What was the result of the pregnancy test? |

| | | |
|---|---|---|
| INCONCL/PENDING | POSITIVE | NEGATIVE |

| | |
|---|---|
| 23-8. | What is the Average Daily Dose of Drug A per Day that you are |
| | prescribing for this patient on today's prescription? |

| | |
|---|---|
| 23-9. | What is the total number of days' supply you are going to write for |
| | on today's prescription? |

### Example 24

### Follow-Up Prescriber Survey for Adult Males

The following survey (or comparable survey) may be used at assist in the gathering of information from a prescriber, wherein the patient is an adult male, at a follow-up patient interview.

24. Follow-up Prescriber Survey
For Adult Males
(to be completed every month)

| | |
|---|---|
| 24-1. | Have you reminded the patient that he must not share his Drug A |
| | with any other person? |

| | | |
|---|---|---|
| Yes | No | Don't Know |

| | |
|---|---|
| 24-2. | Have you reminded the patient that he must not donate to a blood |
| | or sperm bank while taking Drug A? |

| | | |
|---|---|---|
| Yes | No | Don't Know |

| | |
|---|---|
| 24-3. | Is the patient sexually active with a woman who is or could |
| | become pregnant? |

| | | |
|---|---|---|
| Yes | No | Don't Know |

| | |
|---|---|
| 24-4. | Have you reminded the patient that a latex condom must be used |
| | EVERY time he engages in any sexual activity with a female who |
| | is or could become pregnant? |

| | | |
|---|---|---|
| Yes | No | Don't Know |

| | |
|---|---|
| 24-5. | What is the Average Daily Dose of Drug A per Day that you are |
| | prescribing for this patient on today's prescription? |

| | |
|---|---|
| 24-6. | What is the total number of days' supply you are going to write for |
| | on today's prescription? |

Through the use of the illustrate surveys, initial and follow-up patient information may be obtained for transmission to a computer readable storage device (the system 14).

Various modifications of the invention, in addition to those described herein, will be apparent to those skilled in the art from the foregoing description. Such modifications are also intended to fall within the scope of the appended claims.

What is claimed:

1. A method for delivering a drug in patient in need thereof, while avoiding the occurrence of an adverse side effect known or suspected of being caused by the drug, wherein prescriptions for the drug are filled only after a consulting a computer readable medium via an online management system to assure that a prescriber is registered in the medium and qualified to prescribe the drug, a pharmacy is registered in the medium and qualified to fill the prescription for the drug, and the patient is registered in the medium, the method comprising the steps of:
a. defining a plurality of patient risk groups based upon a predefined set of risk parameters for the drug;
b. defining a set of information to be obtained from the patient, which information is probative of the risk that such adverse side effect is likely to occur if the drug is taken by the patient;
c. in response to the information set, assigning the patient to at least one of the risk groups;
d. entering the risk group assignment in the medium before the patient is approved to receive the drug; and
e. registering in the medium a spouse of the patient, designated family member, or guardian to assist the patient in (1) taking the drug consistent with prescription guidelines; (2) preventing diversion of the drug; (3) returning the drug if the drug is no longer suitable for the patient; and/or (4) returning the drug to if the patient expires prior to using all of the drug, wherein.

2. The method of claim 1, wherein the adverse side effect is a teratogenic effect, deep vein thrombosis, pulmonary embolism, neutropenia, thrombocytopenia, or combinations thereof.

3. The method of claim 1, wherein the drug is lenalidomide or thalidomide.

4. The method of claim 1, wherein the online management system comprises at least one of a web server, a database server, and an email server.
